(19) United States
(12) Patent Application Publication
(10) Pub. No.: US 2026/0205625 A1
(43) Pub. Date: Jul. 16, 2026

(54) V-DMC AC DISPLACEMENT CODING WITH FIXED-POINT INVERSE QUANTIZATION OFFSET

(71) Applicant: QUALCOMM Incorporated, San Diego, CA (US)

(72) Inventors: Geert Van der Auwera, San Diego, CA (US); Adarsh Krishnan Ramasubramonian, Irvine, CA (US); Reetu Hooda, San Diego, CA (US); Anique Akhtar, San Diego, CA (US); Marta Karczewicz, San Diego, CA (US)

(21) Appl. No.: 19/446,776

(22) Filed: Jan. 12, 2026

Related U.S. Application Data
(60) Provisional application No. 63/745,191, filed on Jan. 14, 2025.

(51) Int. Cl. H04N 19/597; H04N 19/124; H04N 19/63; H04N 19/70

(52) U.S. Cl. CPC H04N 19/597; H04N 19/124; H04N 19/63; H04N 19/70

(57) ABSTRACT

A device for decoding encoded dynamic mesh data is configured to arithmetically decode a set of quantized wavelet coefficients from a displacement sub-bitstream of the encoded dynamic mesh data; inverse quantize the set of quantized wavelet coefficients to determine a set of fixed-point dequantized coefficient values; determine one or more inverse quantization offset parameters included in the displacement sub-bitstream; determine a fixed-point offset value based on the one or more inverse quantization offset parameters; determine a set of final wavelet coefficients based on the fixed-point offset value and the set of fixed-point dequantized coefficient values; and determine one or more displacement vectors based on the set of final wavelet coefficients.

This application claims the benefit of U.S. Provisional Patent Application No. 63/745,191, filed 14 Jan. 2025, the entire content of which is incorporated herein by reference.

### TECHNICAL FIELD

This disclosure relates to video-based coding of dynamic meshes.

### BACKGROUND

Meshes may be used to represent physical content of a 3-dimensional space. Meshes have utility in a wide variety of situations. For example, meshes may be used in the context of representing the physical content of an environment for purposes of positioning virtual objects in an extended reality (XR), e.g., augmented reality (AR), virtual reality (VR), or mixed reality (MR), application. Mesh compression is a process for encoding and decoding meshes. Encoding meshes may reduce the amount of data required for storage and transmission of the meshes.

### SUMMARY

This disclosure describes techniques for encoding and decoding dynamic mesh data using a fixed-point implementation of an inverse quantization offset process within the arithmetic coded (AC) displacement sub-bitstream. A video-based dynamic mesh coding (V-DMC) encoding device determines displacement vectors, applies a wavelet transform to generate wavelet coefficients, and quantizes the wavelet coefficients. The V-DMC encoding device also determines a fixed-point offset value (e.g., correction term) calculated to reduce quantization error.

To enable this correction, the V-DMC encoding device determines and signals one or more inverse quantization offset parameters within the AC displacement sub-bitstream. This signaling allows the AC displacement sub-bitstream to be self-contained, permitting a V-DMC decoding device to operate without reliance on an atlas metadata sub-bitstream for these offset parameters. The V-DMC encoding device may signal these parameters per level-of-detail (LoD), per displacement dimension, and per quantization zone, such as a zero zone, a positive zone, or a negative zone.

The V-DMC encoding device determines the offset parameters, such as an offset sign and one or more offset values. A V-DMC decoding device receives these parameters from the AC displacement sub-bitstream, arithmetically decodes a set of quantized wavelet coefficients, and performs a fixed-point inverse quantization to determine fixed-point dequantized coefficient values. The V-DMC decoding device calculates the fixed-point offset value based on the signaled parameters and determines a set of final wavelet coefficients by adding this fixed-point offset value to the fixed-point dequantized coefficient values. For inter-coded data, the V-DMC decoding device may add these final wavelet coefficients to fixed-point predictors derived from a reference buffer before determining one or more displacement vectors based on the resulting final wavelet coefficients.

According to an example of this disclosure, a device for decoding encoded dynamic mesh data includes: at least one memory; and processing circuitry in communication with the at least one memory, the processing circuitry configured to: arithmetically decode a set of quantized wavelet coefficients from a displacement sub-bitstream of the encoded dynamic mesh data; inverse quantize the set of quantized wavelet coefficients to determine a set of fixed-point dequantized coefficient values; determine one or more inverse quantization offset parameters included in the displacement sub-bitstream; determine a fixed-point offset value based on the one or more inverse quantization offset parameters; determine a set of final wavelet coefficients based on the fixed-point offset value and the set of fixed-point dequantized coefficient values; and determine one or more displacement vectors based on the set of final wavelet coefficients.

According to an example of this disclosure, a method of decoding encoded dynamic mesh data includes: arithmetically decoding a set of quantized wavelet coefficients from a displacement sub-bitstream of the encoded dynamic mesh data; inverse quantizing the set of quantized wavelet coefficients to determine a set of fixed-point dequantized coefficient values; determining one or more inverse quantization offset parameters included in the displacement sub-bitstream; determining a fixed-point offset value based on the one or more inverse quantization offset parameters; determining a set of final wavelet coefficients based on the fixed-point offset value and the set of fixed-point dequantized coefficient values; and determining one or more displacement vectors based on the set of final wavelet coefficients.

A non-transitory computer-readable medium stores instructions that, when executed by processing circuitry, cause the processing circuitry to: arithmetically decode a set of quantized wavelet coefficients from a displacement sub-bitstream of encoded dynamic mesh data; inverse quantize the set of quantized wavelet coefficients to determine a set of fixed-point dequantized coefficient values; determine one or more inverse quantization offset parameters included in the displacement sub-bitstream; determine a fixed-point offset value based on the one or more inverse quantization offset parameters; determine a set of final wavelet coefficients based on the fixed-point offset value and the set of fixed-point dequantized coefficient values; and determine one or more displacement vectors based on the set of final wavelet coefficients.

According to an example of this disclosure, a device for encoding dynamic mesh data includes: at least one memory; and processing circuitry in communication with the at least one memory, the processing circuitry configured to: determine a set of displacement vectors; determine a set of wavelet coefficients based on the set of displacement vectors; quantize the set of wavelet coefficients to determine a set of quantized wavelet coefficients; determine a fixed-point offset value for the displacement vectors; arithmetically encode the set of quantized wavelet coefficients into a displacement sub-bitstream; and include one or more offset syntax elements indicating the fixed-point offset value in the displacement sub-bitstream.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example implementation of a V-DMC encoder.

FIGS. 3 and 4 show example implementations of V-DMC decoders.

FIG. 5 shows an example of resampling to enable efficient compression of a 2D curve.

FIG. 6 shows a displaced curve that has a subdivision structure, while approximating the shape of the original mesh.

FIG. 7 shows a block diagram of a pre-processing system.

FIG. 8 shows an example implementation of an intra-mode encoder for V-DMC.

FIG. 9 shows an example implementation of an intra-mode decoder for V-DMC.

FIG. 10 shows an example of a displacement decoder.

FIG. 11 illustrates a subdivision scheme.

FIG. 12 shows an example of a displacement decoder process.

FIG. 13A shows an example of a floating-point displacement encoder.

FIG. 13B shows an example of a fixed-point displacement encoder.

FIG. 14A shows an example of a floating-point displacement encoder.

FIG. 14B shows an example of a fixed-point displacement encoder.

FIG. 15 shows an example of a fixed-point displacement encoder.

FIG. 16 is a flowchart illustrating an example process for encoding a mesh.

FIG. 17 is a flowchart illustrating an example process for decoding a compressed bitstream of mesh data.

FIG. 18 is a flowchart illustrating an example process for encoding displacement vectors.

FIG. 19 is a flowchart illustrating an example process for decoding displacement vectors.

### DETAILED DESCRIPTION

A mesh generally refers to a collection of vertices in a three-dimensional (3D) space that collectively represent one or multiple objects in the 3D space. The vertices are connected by edges, and the edges form polygons, which form faces of the mesh. Each vertex may also have one or more associated attributes, such as a texture or a color. In most scenarios, having more vertices produces higher quality, e.g., more detailed and more realistic, meshes. Having more vertices, however, also requires more data to represent the mesh.

To reduce the amount of data needed to represent the mesh, the mesh may be encoded using lossy or lossless encoding. In lossless encoding, the decoded version of the encoded mesh exactly matches the original mesh. In lossy encoding, by contrast, the process of encoding and decoding the mesh causes loss, such as distortion, in the decoded version of the encoded mesh.

In one example of a lossy encoding technique for meshes, a mesh encoder decimates an original mesh to determine a base mesh. To decimate the original mesh, the mesh encoder subsamples or otherwise reduces the number of vertices in the original mesh, such that the base mesh is a rough approximation, with fewer vertices, of the original mesh. The mesh encoder then subdivides the decimated mesh. That is, the mesh encoder estimates the locations of additional vertices in between the vertices of the base mesh. The mesh encoder then deforms the subdivided mesh by moving the vertices in a manner that makes the deformed mesh more closely match the original mesh.

After determining a desired base mesh and deformation of the subdivided mesh, the mesh encoder generates a bitstream that includes data for constructing the base mesh and data for performing the deformation. The data defining the deformation may be signaled as a series of displacement vectors that indicate the movement, or displacement, of the additional vertices determined by the subdividing process. To decode a mesh from the bitstream, a mesh decoder reconstructs the base mesh based on the signaled information, applies the same subdivision process as the mesh encoder, and then displaces the additional vertices based on the signaled displacement vectors.

This disclosure describes techniques related to the fixed-point implementation and integration of the V-DMC inverse quantization offset process in the arithmetic coded (AC) displacement sub-bitstream. The techniques of this disclosure may, for example, be included in the V-DMC technology that is being standardized in MPEG WG7 (3DGH).

In Video-based Dynamic Mesh Coding (V-DMC), displacement vectors may be wavelet transformed, quantized, and coded using an arithmetic coder (AC) to generate an AC displacement sub-bitstream. This AC sub-bitstream may use inter-prediction of wavelet coefficients and a fixed-point inverse quantization process to reconstruct coefficients. While an inverse quantization offset tool exists to reduce quantization error, this tool is typically implemented using floating-point operations. Integrating these floating-point operations into the fixed-point inter-prediction loop of the AC sub-bitstream is problematic, as platform-dependent operations may cause a mismatch, or “drift,” between the encoder and decoder, degrading prediction quality.

A further challenge in existing approaches relates to data signaling. The AC displacement sub-bitstream is expected to be self-contained to allow for independent reconstruction. However, the parameters for the existing inverse quantization offset tool are signaled in the atlas metadata sub-bitstream, not the AC displacement sub-bitstream. This dependency prevents the AC displacement sub-bitstream from being fully self-contained.

The techniques of this disclosure address these challenges by providing a fixed-point implementation of the inverse quantization offset tool integrated directly within the AC displacement sub-bitstream. A V-DMC encoding device determines displacement vectors, quantizes corresponding wavelet coefficients, and determines offset parameters for reducing quantization error. The V-DMC encoding device signals these offset parameters directly within the AC displacement sub-bitstream.

A V-DMC decoding device arithmetically decodes the quantized wavelet coefficients from the sub-bitstream and performs a fixed-point inverse quantization. The V-DMC decoding device also determines the inverse quantization offset parameters from the AC displacement sub-bitstream. The V-DMC decoding device calculates a fixed-point offset value based on these parameters using fixed-point arithmetic, such as bit-shift operations. The V-DMC decoding device then adds the resulting fixed-point offset value to the fixed-point dequantized coefficient values to determine final wavelet coefficients. By implementing the offset tool entirely in fixed-point arithmetic, the techniques mitigate the potential for inter-prediction drift. Furthermore, by signaling all necessary offset parameters within the AC displacement sub-bitstream, the techniques enable the sub-bitstream to be self-contained, reducing quantization error and improving the accuracy of the reconstructed displacements.

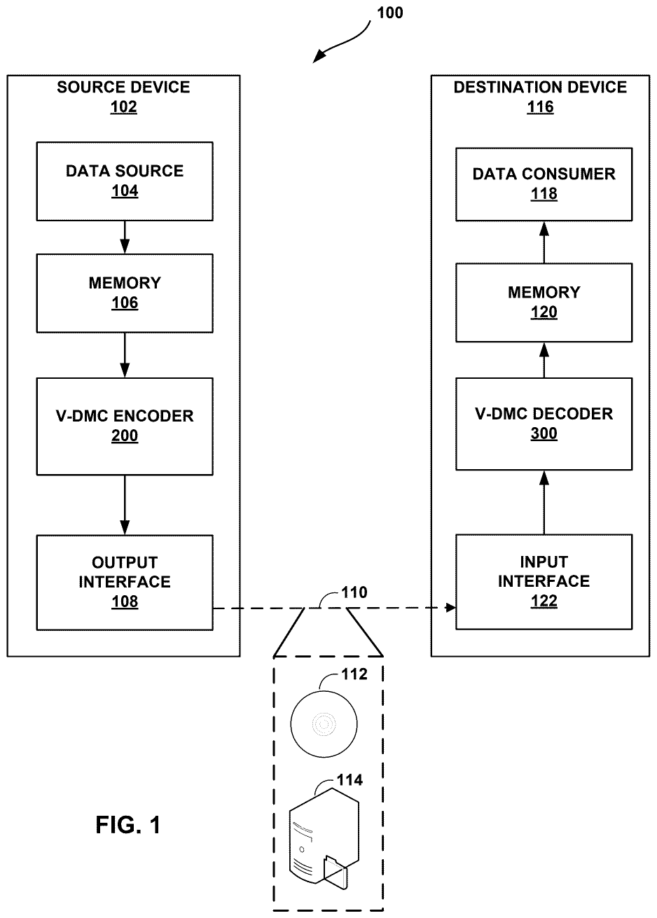

FIG. 1 is a block diagram illustrating an example encoding and decoding system 100 that may perform the techniques of this disclosure. The techniques of this disclosure are generally directed to coding (encoding and/or decoding) meshes. The coding may be effective in compressing and/or decompressing data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to displacement vector quantization. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to displacement vector quantization. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded data) and may provide a sequential series of “frames” of the data to V-DMC encoder 200, which encodes data for the frames. Data source 104 of source device 102 may include a mesh capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, mesh data may be computer-generated from scanner, camera, sensor or other data. For example, data source 104 may generate computer graphics-based data as the source data, or produce a combination of live data, archived data, and computer-generated data. In each case, V-DMC encoder 200 encodes the captured, pre-captured, or computer-generated data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to V-DMC encoder 200 and/or output interface 108, and destination device 116 may include an SoC device to perform the functionality attributed to V-DMC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

This disclosure describes techniques that may provide various improvements in the vertex attribute encoding for base meshes in the video-based coding of dynamic meshes (V-DMC), which is being standardized in MPEG WG7 (3DGH). In V-DMC, the base mesh connectivity is encoded using an edgebreaker implementation, and the base mesh attributes can be encoded using residual encoding with attribute prediction. This disclosure describes techniques to implement a transform and/or quantization on the attribute and/or the predictions and/or the residuals for the base mesh encoding, which may improve the coding performance of the base mesh encoding.

Working Group 7 (WG7), often referred to as the 3D Graphics and Haptics Coding Group (3DGH), is presently engaged in standardizing the video-based dynamic mesh coding (V-DMC) for XR applications. The current testing model includes preprocessing input meshes into simplified versions called “base meshes.” These base meshes, which often contain fewer vertices than the original mesh, are encoded using a base mesh coder also called a static mesh coder. The preprocessing also generates displacement vectors as well as a texture attribute map that are both encoded using a video encoder. If the mesh is encoded in a lossless manner, then the base mesh is no longer a simplified version and is used to encode the original mesh.

The base mesh encoder encodes the connectivity of the mesh as well as the attributes associated with each vertex which typically involves the position and a coordinate for the texture but are not limited to these attributes. The position includes 3D coordinates (x,y,z) of the vertex while, the texture is stored as a 2D UV coordinate (u,v) that points to a texture map image pixel location. The base mesh in V-DMC is encoded using an edgebreaker algorithm, while the connectivity is encoded using a CLERS op code. The residual of the attribute is encoded using prediction from the previously encoded/decoded vertices. Other types of static mesh coders, such as Google Draco, may also be used. Other types of coding may also be used for the connectivity coding and residual coding.

The edgebreaker algorithm is described in Jean-Eudes Marvie, Olivier Mocquard, [V-DMC][EE4.4] An efficient edgebreaker implementation, ISO/IEC JTC1/SC29/WG7, m63344, April 2023 (hereinafter “m63344”), which is hereby incorporated by reference. The CLERS op code is described in J. Rossignac, “3D compression made simple: Edgebreaker with ZipandWrap on a corner-table,” in Proceedings International Conference on Shape Modeling and Applications, Genova, Italy, 2001 (hereinafter “Rossignac”) and H. Lopes, G. Tavares, J. Rossignac, A. Szymczak and A. Safonova, “Edgebreaker: a simple compression for surfaces with handles.” in ACM Symposium on Solid Modeling and Applications, Saarbrucken, 2002 (hereinafter “Lopes”), which are both hereby incorporated by reference.

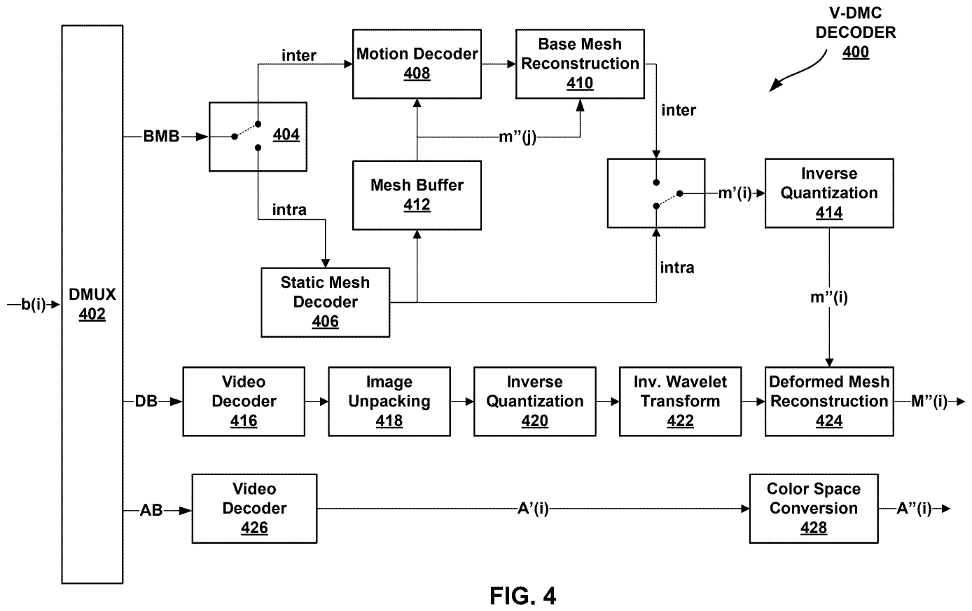

Additionally, V-DMC encoder 200 may estimate the motion of the base mesh vertices and code the motion vectors into the bitstream. The reconstructed base meshes may be subdivided into finer meshes with additional vertices and, hence, additional triangles. V-DMC encoder 200 may refine the positions of the subdivided mesh vertices to approximate the original mesh. The refinements or vertex displacement vectors may be coded into the bitstream. In the current test model, the displacement vectors are wavelet transformed (lifting scheme), quantized, and the coefficients are either packed into a 2D frame or directly coded with an arithmetic coder after inter prediction. The sequence of video frames is coded with a typical video coder, for example, High Efficiency Video Coding (HEVC) Standard or the Versatile Video Coding (VVC) standard, into the bitstream. In addition, the sequence of texture frames is coded with a video coder. The simplified architecture of the V-DMC decoder is illustrated in FIG. 4.

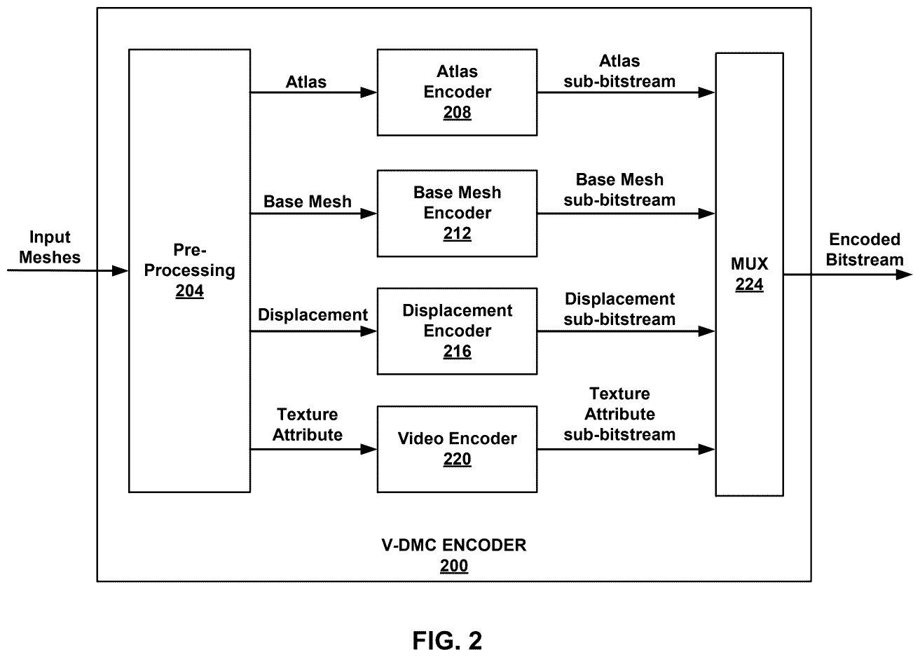

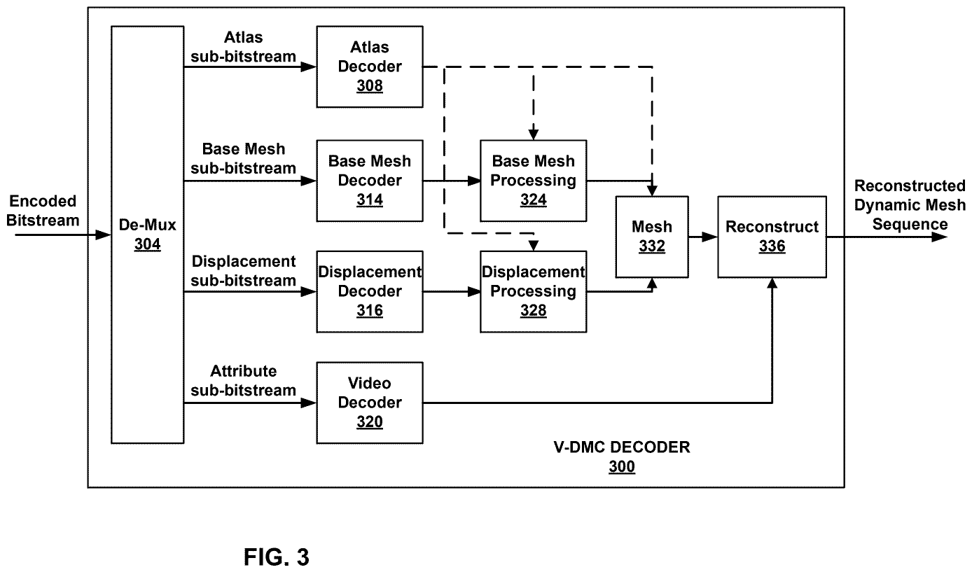

FIGS. 2 and 3 show the overall system model for the current V-DMC test Model™ encoder (V-DMC encoder 200 in FIG. 2) and decoder (V-DMC decoder 300 in FIG. 3) architecture. V-DMC encoder 200 performs volumetric media conversion, and V-DMC decoder 300 performs a corresponding reconstruction. The 3D media is converted to a series of sub-bitstreams: base mesh, displacement, and texture attributes. Additional atlas information is also included in the bitstream to enable inverse reconstruction, as described in N00680.

FIG. 2 shows an example implementation of V-DMC encoder 200. In the example of FIG. 2, V-DMC encoder 200 includes pre-processing unit 204, atlas encoder 208, base mesh encoder 212, displacement encoder 216, video encoder 220, and multiplexer (MUX) 224. Pre-processing unit 204 receives an input mesh sequence and generates atlas parameters, a base mesh, the displacement vectors, and the texture attribute maps. Atlas encoder 208 encodes the atlas parameters. Base mesh encoder 212 encodes the base mesh. Displacement encoder 216 encodes the displacement vectors, for example as V3C video components or using arithmetic displacement coding. Video encoder 220 encodes the texture attribute components, e.g., texture or material information, using any video codec, such as the High Efficiency Video Coding (HEVC) Standard or the Versatile Video Coding (VVC) standard. MUX 224 combines the atlas sub-bitstream produced by atlas encoder 208, the base mesh sub-bitstream produced by base mesh encoder 212, the displacement sub-bitstream produced by displacement encoder 216, and the texture attribute sub-bitstream produced by video encoder 220 into a single encoded bitstream that may be stored or transmitted.

Aspects of V-DMC encoder 200 will now be described in more detail. Pre-processing unit 204 represents the 3D volumetric data as a set of base meshes and corresponding refinement components. This is achieved through a conversion of input dynamic mesh representations into a number of V3C components: a base mesh, a set of displacements, a 2D representation of the texture map, and an atlas. The base mesh component is a simplified low-resolution approximation of the original mesh in the lossy compression and is the original mesh in the lossless compression. The base mesh component can be encoded by base mesh encoder 212 using any mesh codec.

Base mesh encoder 212 may, for example, employ an implementation of the Edgebreaker algorithm, e.g., m63344, for encoding the base mesh where the connectivity is encoded using a CLERS op code, e.g., from Rossignac and Lopes, and the residual of the attribute is encoded using prediction from the previously encoded/decoded vertices' attributes.

Aspects of base mesh encoder 212 will now be described in more detail. One or more submeshes are input to base mesh encoder 212. Submeshes are generated by pre-processing unit 204. Submeshes are generated from original meshes by utilizing semantic segmentation. Each base mesh may include one or more submeshes.

Base mesh encoder 212 may process connected components. Connected components include a cluster of triangles that are connected by their neighbors. A submesh can have one or more connected components. Base mesh encoder 212 may encode one “connected component” at a time for connectivity and attributes encoding and then performs entropy encoding on all “connected components”.

FIG. 3 shows an example implementation of V-DMC decoder 300. In the example of FIG. 3, V-DMC decoder 300 includes demultiplexer 304, atlas decoder 308, base mesh decoder 314, displacement decoder 316, video decoder 320, base mesh processing unit 324, displacement processing unit 328, mesh generation unit 332, and reconstruction unit 336.

Demultiplexer 304 separates the encoded bitstream into an atlas sub-bitstream, a base-mesh sub-bitstream, a displacement sub-bitstream, and a texture attribute sub-bitstream. Atlas decoder 308 decodes the atlas sub-bitstream to determine the atlas information to enable inverse reconstruction. Base mesh decoder 314 decodes the base mesh sub-bitstream, and base mesh processing unit 324 reconstructs the base mesh. Displacement decoder 316 decodes the displacement sub-bitstream, and displacement processing unit 328 reconstructs the displacement vectors. Mesh generation unit 332 modifies the base mesh based on the displacement vector to form a displaced mesh.

Video decoder 320 decodes the texture attribute sub-bitstream to determine the texture attribute map, and reconstruction unit 336 associates the texture attributes with the displaced mesh to form a reconstructed dynamic mesh.

A more detailed description of the proposal that was selected as the starting point for the V-DMC standardization will now be described. The following description details the displacement vector coding in the current V-DMC test model and working draft, WD 5.0 of V-DMC, ISO/IEC JTC1/SC29/WG7, N00744, October 2023, incorporated herein by reference.

FIG. 4 shows V-DMC decoder 400, which may be configured to perform either intra- or inter-decoding. V-DMC decoder 400 represents an example implementation of V-DMC decoder 300. The processes described with respect to FIG. 4 may also be performed, in full or in part, by V-DMC encoder 200.

V-DMC decoder 400 includes demultiplexer (DMUX) 402, which receives compressed bitstream b (i) and separates the compressed bitstream into a base mesh bitstream (BMB), a displacement bitstream (DB), and an attribute bitstream (AB). Mode select unit 404 determines if the base mesh data is encoded in an intra mode or an inter mode. If the base mesh is encoded in an intra mode, then static mesh decoder 406 decodes the mesh data without reliance on any previously decoded meshes. If the base mesh is encoded in an inter mode, then motion decoder 408 decodes motion, and base mesh reconstruction unit 410 applies the motion to an already decoded mesh (m″(j)) stored in mesh buffer 412 to determine a reconstructed quantized base mesh (m′(i))). Inverse quantization unit 414 applies an inverse quantization to the reconstructed quantized base mesh to determine a reconstructed base mesh (m″(i)).

Video decoder 416 decodes the displacement bitstream to determine a set or frame of quantized transform coefficients. Image unpacking unit 418 unpacks the quantized transform coefficients. For example, video decoder 416 may decode the quantized transform coefficients into a frame, where the quantized transform coefficients are organized into blocks with particular scanning orders. Image unpacking unit 418 converts the quantized transform coefficients from being organized in the frame into an ordered series. In some implementations, the quantized transform coefficients may be directly coded, using a context-based arithmetic coder for example, and unpacking may be unnecessary.

Regardless of whether the quantized transform coefficients are decoded directly or in a frame, inverse quantization unit 420 inverse quantizes, e.g., inverse scales, quantized transform coefficients to determine de-quantized transform coefficients. Inverse wavelet transform unit 422 applies an inverse transform to the de-quantized transform coefficients to determine a set of displacement vectors. Deformed mesh reconstruction unit 424 deforms the reconstructed base mesh using the decoded displacement vectors to determine a decoded mesh (M″(i)).

Video decoder 426 decodes the attribute bitstream to determine decoded attribute values (A′(i)), and color space conversion unit 428 converts the decoded attribute values into a desired color space to determine final attribute values (A″(i)). The final attribute values correspond to attributes, such as color or texture, for the vertices of the decoded mesh.

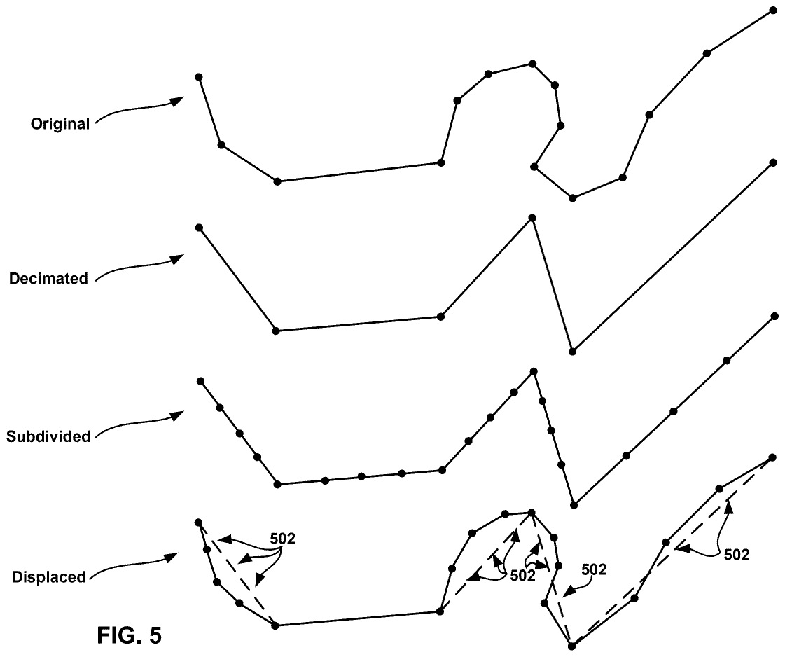

FIG. 5 illustrates the basic idea behind the proposed pre-processing scheme by using a 2D curve. The same concepts are applied to the input 3D mesh M(i) to produce a base mesh m(i) and a displacement field d(i).

In FIG. 5, the input 2D curve (represented by a 2D polyline), referred to as the “original” curve, is first downsampled to generate a base curve/polyline, referred to as the “decimated” curve. A subdivision scheme, such as that described in Garland et al, Surface Simplification Error Metrics Using Quadric (https://www.cs.cmu.edu/~garland/Papers/quadrics.pdf), is then applied to the decimated polyline to generate a “subdivided” curve. For instance, in FIG. 5, a subdivision scheme using an iterative interpolation scheme is applied. The scheme includes inserting at each iteration a new point in the middle of each edge of the polyline. In the example illustrated, two subdivision iterations are applied.

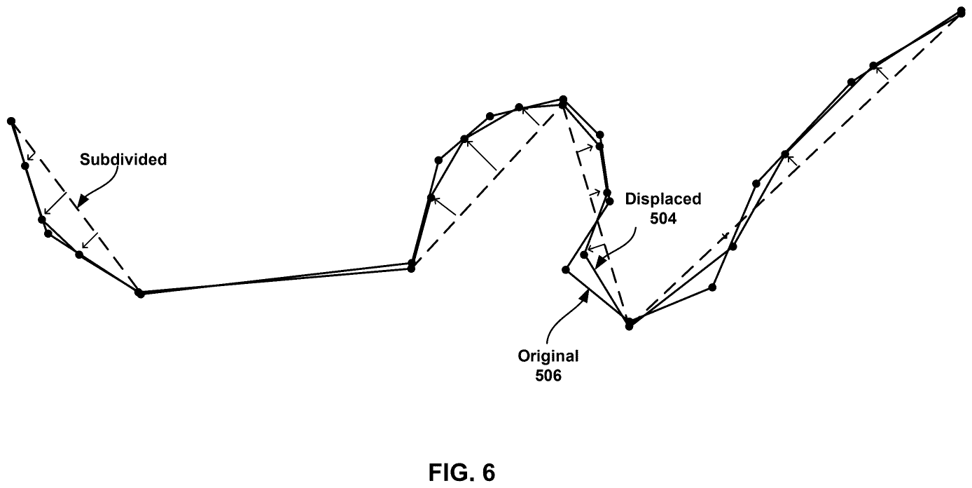

The proposed scheme is independent of the chosen subdivision scheme and may be combined with other subdivision schemes. The subdivided polyline is then deformed to get a better approximation of the original curve. A displacement vector is computed for each vertex of the subdivided mesh (arrows 502 in FIG. 5) such that the shape of the displaced curve is as close as possible to the shape of the original curve (see FIG. 6). As illustrated by portion 504 of the displaced curve and portion 506 of the original curve, for example, the displaced curve may not perfectly match the original curve.

An advantage of the subdivided curve is that the subdivided curve has a subdivision structure that allows efficient compression, while offering a faithful approximation of the original curve. The compression efficiency is obtained based on:
The decimated/base curve has a low number of vertices and requires a limited number of bits to be encoded/transmitted.
The subdivided curve is automatically generated by the decoder once the base/decimated curve is decoded (i.e., no need for any information other than the subdivision scheme type and subdivision iteration count).
The displaced curve is generated by decoding the displacement vectors associated with the subdivided curve vertices. Besides allowing for spatial/quality scalability, the subdivision structure enables efficient transforms such as wavelet decomposition, which can offer high compression performance.

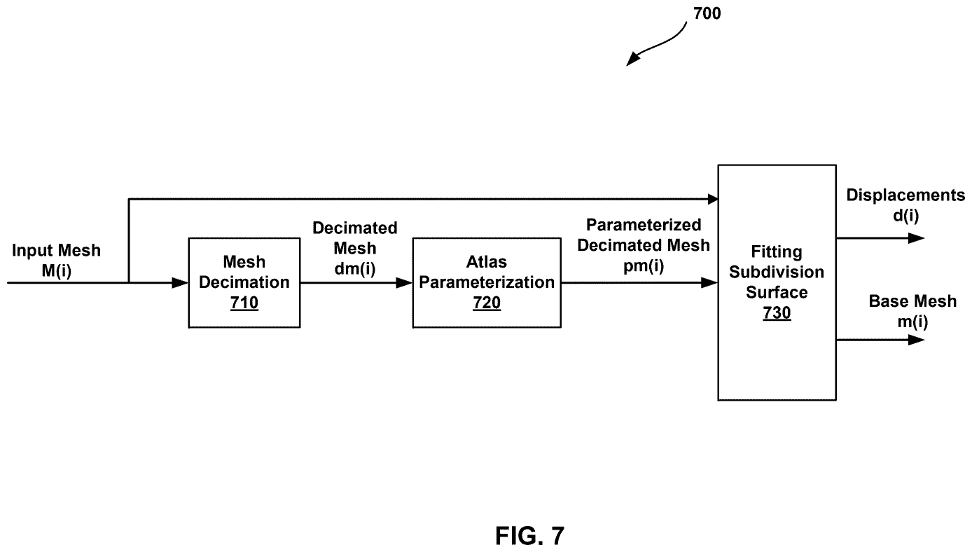

FIG. 7 shows a block diagram of pre-processing system 700 which may be included in V-DMC encoder 200. In the example of FIG. 7, pre-processing system 700 includes mesh decimation unit 710, atlas parameterization unit 720, and subdivision surface fitting unit 730.

Mesh decimation unit 710 uses a simplification technique to decimate the input mesh M(i) and produce the decimated mesh dm(i). The decimated mesh dm(i) is then re-parameterized by atlas parameterization unit 720, which may for example use the UVAtlas tool. The generated mesh is denoted as pm(i). The UVAtlas tool considers only the geometry information of the decimated mesh dm(i) when computing the atlas parameterization, which is likely sub-optimal for compression purposes. Other parameterization schemes or tools may also be used with the proposed framework.

Applying re-parameterization to the input mesh makes it possible to generate a lower number of patches, with a patch representing a connected region of a surface. This reduces parameterization discontinuities and may lead to better RD (rate-distortion) performance. Subdivision surface fitting unit 730 takes as input the re-parameterized mesh pm(i) and the input mesh M(i) and produces the base mesh m(i) together with a set of displacements d(i). First, pm(i) is subdivided by applying the subdivision scheme. The displacement field d(i) is computed by determining for each vertex of the subdivided mesh the nearest point on the surface of the original mesh M(i).

For the Random Access (RA) condition, a temporally consistent re-meshing may be computed by considering the base mesh m(j) of a reference frame with index j as the input for subdivision surface fitting unit 730. This makes it possible to produce the same subdivision structure for the current mesh M′(i) as the one computed for the reference mesh M′(j). Such a re-meshing process makes it possible to skip the encoding of the base mesh m(i) and re-use the base mesh m(j) associated with the reference frame M(j). This may also enable better temporal prediction for both the attribute and geometry information. For example, a motion field f(i) describing how to move the vertices of m(j) to match the positions of m(i) is computed and encoded. Such time-consistent re-meshing may not always be possible. The techniques of this disclosure may also include comparing the distortion obtained with and without the temporal consistency constraint and choosing the mode that offers a desirable RD compromise.

Note that the pre-processing system is not normative and may be replaced by any other system that produces displaced subdivision surfaces. A possible efficient implementation would constrain the 3D reconstruction unit to directly generate displaced subdivision surface and avoids the need for such pre-processing.

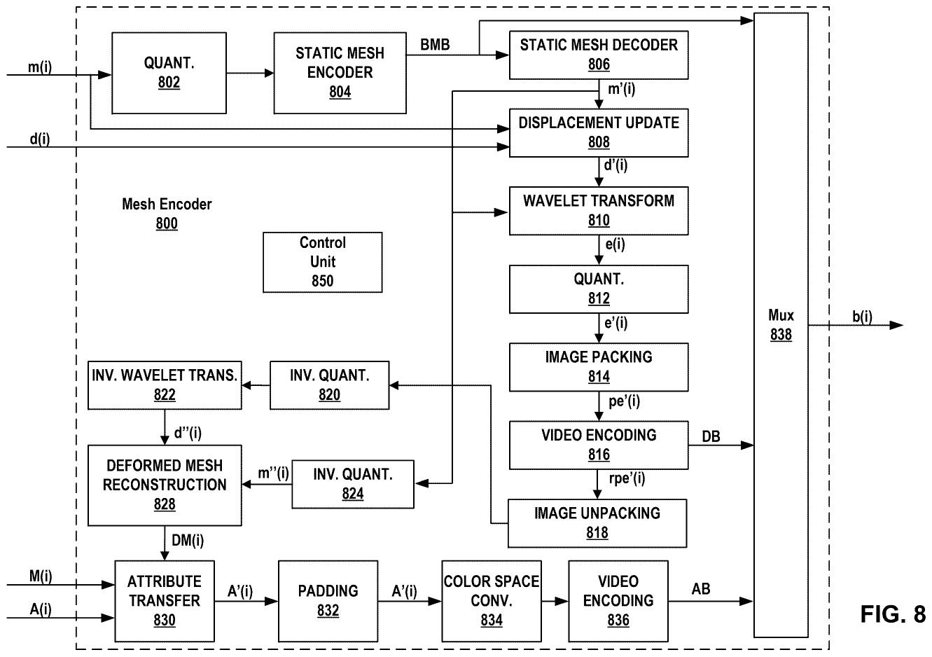

FIG. 8 shows V-DMC encoder 800, which is configured to implement an intra encoding process. V-DMC encoder 800 represents an example implementation of V-DMC encoder 200.

FIG. 8 includes the following abbreviations:
m(i)—Base mesh
d(i)—Displacements
m″(i)—Reconstructed Base Mesh
d″(i)—Reconstructed Displacements
A(i)—Attribute Map
A′(i)—Updated Attribute Map
M(i)—Static/Dynamic Mesh
DM(i)—Reconstructed Deformed Mesh
m′(i)—Reconstructed Quantized Base Mesh
d′(i)—Updated Displacements
e(i)—Wavelet Coefficients
e′(i)—Quantized Wavelet Coefficients
pe′(i)—Packed Quantized Wavelet Coefficients
rpe′(i)—Reconstructed Packed Quantized Wavelet Coefficients
AB—Compressed attribute bitstream
DB—Compressed displacement bitstream
BMB—Compressed base mesh bitstream

V-DMC encoder 200 receives base mesh m(i) and displacements d(i), for example from pre-processing system 600 of FIG. 6. V-DMC encoder 200 also retrieves mesh M(i) and attribute map A(i).

Quantization unit 802 quantizes the base mesh, and static mesh encoder 804 encodes the quantized based mesh to generate a compressed base mesh bitstream. Static mesh decoder 806 then decodes the compressed bitstream. To the extent the encoding of the base mesh by static mesh encoder 804 is lossy, this encoding followed by decoding may determine the loss so that V-DMC encoder 800 may determine displacement vectors that reduce or minimize the loss.

Displacement update unit 808 uses the reconstructed quantized base mesh m′(i) to update the displacement field d(i) to generate an updated displacement field d′(i). This process considers the differences between the reconstructed base mesh m′(i) and the original base mesh m(i). By exploiting the subdivision surface mesh structure, wavelet transform unit 810 applies a wavelet transform to d′(i) to generate a set of wavelet coefficients. The scheme is agnostic of the transform applied and may leverage any other transform, including the identity transform. Quantization unit 812 quantizes wavelet coefficients, and image packing unit 814 packs the quantized wavelet coefficients into a 2D image/video that can be compressed using a traditional image/video encoder in the same spirit as V-PCC to generate a displacement bitstream.

Attribute transfer unit 830 receives the reconstructed deformed mesh DM(i) and converts the original attribute map A(i) to an updated attribute map A′(i) that corresponds to DM(i). Padding unit 832 pads the updated attributed map by, for example, filling patches of the frame that have empty samples with interpolated samples that may improve coding efficiency and reduce artifacts. Color space conversion unit 834 converts the attribute map into a different color space, and video encoding unit 836 encodes the updated attribute map in the new color space, using for example a video codec, to generate an attribute bitstream.

Multiplexer 838 combines the compressed attribute bitstream, compressed displacement bitstream, and compressed base mesh bitstream into a single compressed bitstream.

Image unpacking unit 818 and inverse quantization unit 820 apply image unpacking and inverse quantization to the reconstructed packed quantized wavelet coefficients generated by video encoding unit 816 to obtain the reconstructed version of the wavelet coefficients. Inverse wavelet transform unit 822 applies and inverse wavelet transform to the reconstructed wavelet coefficient to determine reconstructed displacements d″(i).

Inverse quantization unit 824 applies an inverse quantization to the reconstructed quantized base mesh m′(i) to obtain a reconstructed base mesh m″(i). Deformed mesh reconstruction unit 828 subdivides m″(i) and applies the reconstructed displacements d″(i) to its vertices to obtain the reconstructed deformed mesh DM(i).

Image unpacking unit 818, inverse quantization unit 820, inverse wavelet transform unit 822, and deformed mesh reconstruction unit 828 represent a displacement decoding loop. Inverse quantization unit 824 and deformed mesh reconstruction unit 828 represent a base mesh decoding loop. V-DMC encoder 800 includes the displacement decoding loop and the base mesh decoding loop so that V-DMC encoder 800 can make encoding decisions, such as determining an acceptable rate-distortion tradeoff, based on the same decoded mesh that a mesh decoder will generate, which may include distortion due to the quantization and transforms. V-DMC encoder 800 may also use decoded versions of the base mesh, reconstructed mesh, and displacements for encoding subsequent base meshes and displacements.

Control unit 850 generally represents the decision making functionality of V-DMC encoder 800. During an encoding process, control unit 850 may, for example, make determinations with respect to mode selection, rate allocation, quality control, and other such decisions.

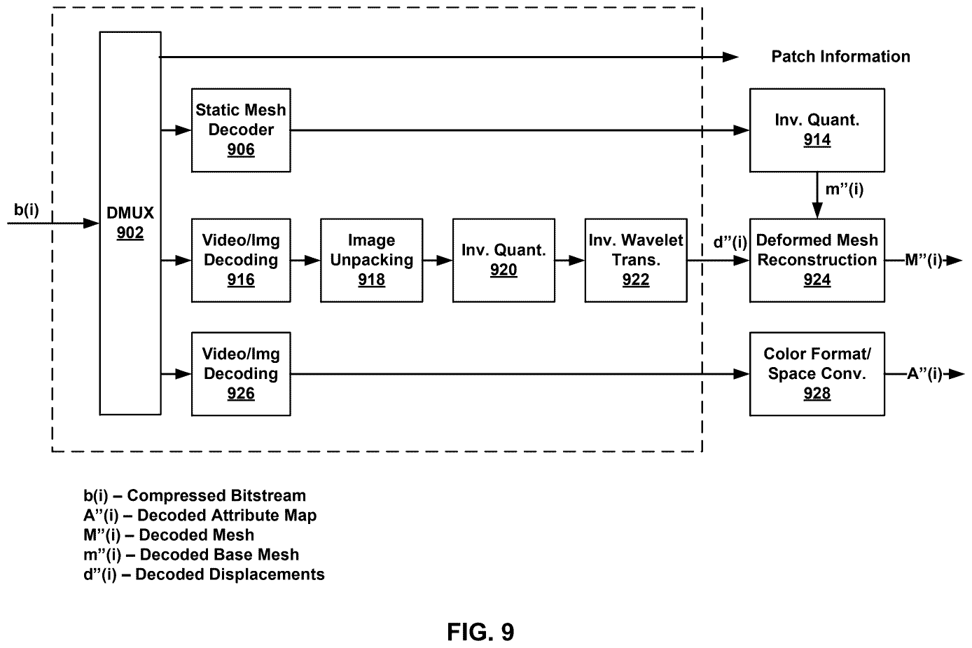

FIG. 9 shows a block diagram of an intra decoder which may, for example, be part of V-DMC decoder 300. De-multiplexer (DMUX) 902 separates compressed bitstream (bi) into a mesh sub-stream, a displacement sub-stream for positions and potentially for each vertex attribute, zero or more attribute map sub-streams, and an atlas sub-stream containing patch information in the same manner as in V3C/V-PCC.

De-multiplexer 902 feeds the mesh sub-stream to static mesh decoder 906 to generate the reconstructed quantized base mesh rqm′(i). Inverse quantization unit 914 inverse quantizes the base mesh to determine the decoded base mesh dm″(i). Video/image decoding unit 916 decodes the displacement sub-stream, and image unpacking unit 918 unpacks the image/video to determine quantized transform coefficients, e.g., wavelet coefficients. Inverse quantization unit 920 inverse quantizes the quantized transform coefficients to determine dequantized transform coefficients. Inverse transform unit 922 generates the decoded displacement field dd″(i) by applying the inverse transform to the unquantized coefficients. Deformed mesh reconstruction unit 924 generates the final decoded mesh (DM″(i)) by applying the reconstruction process to the decoded base mesh dm″(i) and by adding the decoded displacement field dd″(i). The attribute sub-stream is directly decoded by video/image decoding unit 926 to generate a decoded attribute map DA′(i). Color format/space conversion unit 928 may convert DA′(i) into a different format or color space to produce decoded attribute map DA″(i) in a desired color space or format.

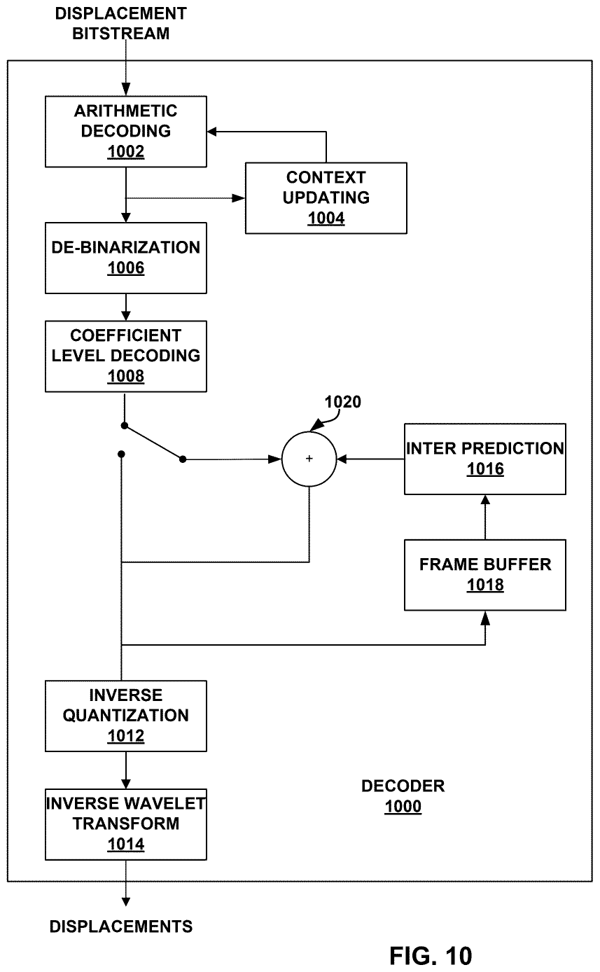

As an addition or alternative to packing the quantized wavelet coefficients in frames and coding as images or video, a scheme that directly codes the quantized wavelet coefficients with a block-based arithmetic coder may also be used. This scheme is illustrated in FIG. 10. The decoded quantized wavelet coefficients are inter predicted from the reference buffer, which contains quantized wavelet coefficients from prior frames, for example, the preceding frame. In the example of FIG. 10, decoder 1000 performs context-based arithmetic decoding 1002 of a displacement bitstream based on a context update 1004. Decoder 1000 performs de-binarization 1006 on the context decoded bitstream to determine values for syntax elements and performs coefficient level decoding 1008 on the syntax elements. For intra coded displacements, decoder 1000 performs inverse quantization 1012 on the coefficient levels to determine de-quantized coefficient levels, and then performs an inverse wavelet transform 1014 on the de-quantized coefficient levels to determine the displacements. For inter coded displacements, decoder 1000 performs inter prediction 1016 using reference frames stored in a frame buffer 1018 and adds 1020 the prediction values to the coefficient levels to determine final coefficient levels. Decoder 1000 then performs inverse quantization 1012 on the final coefficient levels to determine de-quantized coefficient levels, and then performs an inverse wavelet transform 1014 on the de-quantized coefficient levels to determine the displacements.

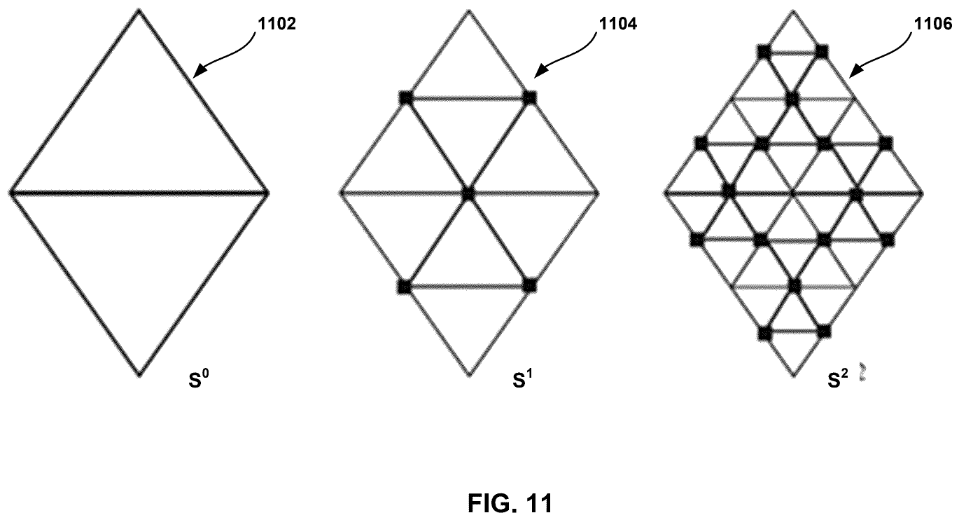

V-DMC encoder 200 and V-DMC decoder 300 may be configured to implement a subdivision scheme. Various subdivision schemes could be considered. A possible solution is the mid-point subdivision scheme, which at each subdivision iteration subdivides each triangle into four sub-triangles as described in FIG. 11. New vertices are introduced in the middle of each edge. In the example, FIG. 11, triangles 1102 are subdivided to obtain triangles 1104, and triangles 1104 are subdivided to obtain triangles 1106. The subdivision process is applied independently to the geometry and to the texture coordinates since the connectivity for the geometry and for the texture coordinates is usually different. The sub-division scheme computes the position Pos(ν₁₂) of a newly introduced vertex ν₁₂ at the center of an edge (ν₁, ν₂), as follows:

$$Pos ( {v}_{12} ) = \frac{1}{2} ( Pos ( {v}_{1} ) + Pos ( {v}_{2} ) ) ,$$

where Pos(ν₁) and Pos(ν₂) are the positions of the vertices ν₁ and ν₂.

The same process is used to compute the texture coordinates of the newly created vertex. For normal vectors, an extra normalization step is applied as follows:

$$N ( {v}_{12} ) = \frac{N ( {v}_{1} ) + N ( {v}_{2} )}{‖ N ( {v}_{1} ) + N ( {v}_{2} ) ‖} ,$$

here:
N(ν₁₂), N(ν₁), and N(ν₂) are the normal vectors associated with the vertices ν₁₂, ν₁, and ν₂, respectively.
∥x∥ is the norm2 of the vector x.

V-DMC encoder 200 and V-DMC decoder 300 may be configured to apply wavelet transforms. Various wavelet transforms may be applied. The results reported for CfP are based on a linear wavelet transform.

The prediction process is defined as follows:

$$Signal ( v ) ← Signal ( v ) - \frac{1}{2} ( Signal ( {v}_{1} ) + Signal ( {v}_{2} ) )$$

where
ν is the vertex introduced in the middle of the edge (ν₁, ν₂), and
Signal(ν), Signal(ν₁), and Signal(ν₂) are the values of the geometry/vertex attribute signals at the vertices ν, ν₁, and ν₂, respectively.

The updated process is as follows:

$$Signal ( v ) ← Signal ( v ) + \frac{1}{8} {\sum }_{w ∈ {v}^{*}} Signal ( w )$$

where ν* is the set of neighboring vertices of the vertex ν.

The scheme may allow to skip the update process. The wavelet coefficients could be quantized e.g., by using a uniform quantizer with a dead zone.

V-DMC encoder 200 and V-DMC decoder 300 may be configured to use local or canonical coordinate systems for displacements. The displacement field d(i) is defined in the same cartesian coordinate system as the input mesh. A possible optimization is to transform d(i) from this canonical coordinate system to a local coordinate system, which is defined by the normal to the subdivided mesh at each vertex.

The advantage of considering a local coordinate system for the displacements is the possibility to quantize more heavily the tangential components of the displacements compared to the normal component. The normal component of the displacement has more significant impact on the reconstructed mesh quality than the two tangential components.

V-DMC encoder 200 and V-DMC decoder 300 may be configured to pack (and unpack) wavelet coefficients. The following scheme may be used to pack the wavelet coefficients into a 2D image:
Traverse the coefficients from low to high frequency.
For each coefficient, determine the index of the N×M pixel block (e.g., N=M=16) in which it should be stored following a raster order for blocks.

The position within the N×M pixel block is computed by using a Morton order to increase locality.

Other packing schemes may also be used (e.g., zigzag order, raster order). The encoder may explicitly signal in the bitstream the used packing scheme (e.g., atlas sequence parameters). This could be done at patch, patch group, tile, or sequence level.

V-DMC encoder 200 and V-DMC decoder 300 may be configured to perform displacement video encoding and decoding. The proposed scheme is agnostic as to which video coding technology is used. When coding the displacement wavelet coefficients, a lossless approach may be used since the quantization is applied in a separate module. Another approach is to rely on the video encoder to compress the coefficients in a lossy manner and apply a quantization either in the original or transform domain.

V-DMC encoder 200 and V-DMC decoder 300 may be configured to implement displacement encoding. The proposed scheme is agnostic of which video coding technology is used. When coding the displacement wavelet coefficients, a lossless approach may be used since the quantization is applied in a separate module. Another approach is to rely on the video encoder to compress the coefficients in a lossy manner and apply a quantization either in the original or transform domain.

Alternatively, V-DMC includes a dedicated sub-bitstream (Annex J), as described in Text of ISO/IEC DIS 23090-29 Video-based mesh coding, ISO/IEC JTC1/SC29/WG7, N01027, November 2024, (hereinafter “N01027”), to arithmetically code the quantized displacement wavelet coefficients. In this scheme, inter prediction may be performed.

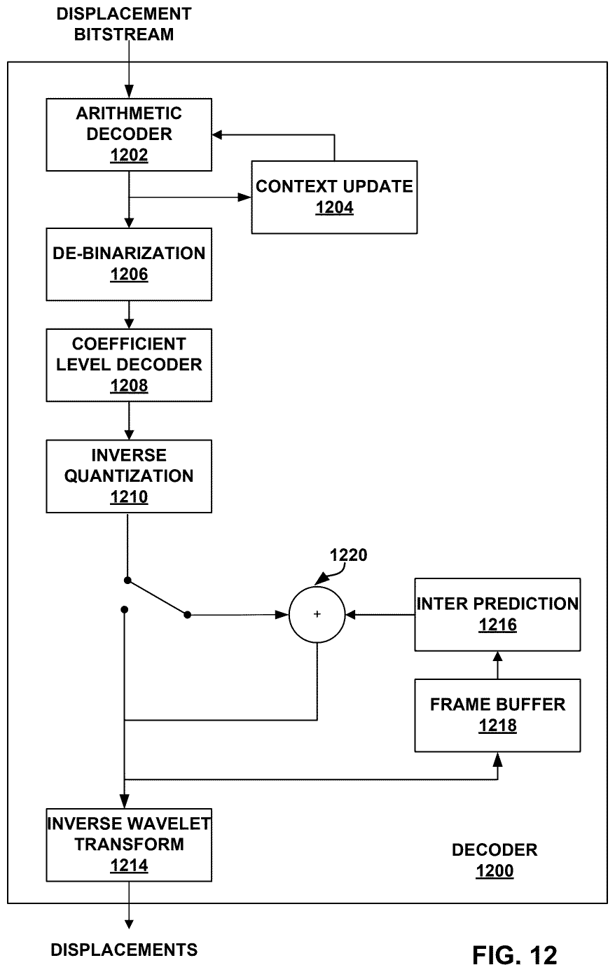

V-DMC encoder 200 and V-DMC decoder 300 may be configured to implement AC displacement coding with a fixed-point inverse quantizer. As described above, inter prediction is performed on coefficients (lifting scheme) after the arithmetic decoding of displacements. H. Nishimura, K. Kawamura, K. Kishimoto, J. Xu, “[V-DMC][EE4.7 Test 5.1] Quantization after Inter Prediction in Arithmetic Coding-based Displacement Coding,” ISO/IEC JTC1/SC29/WG7, m64391, July 2023 introduced inter prediction of the wavelet coefficients themselves after inverse quantization as is illustrated in FIG. 12. The inverse quantized coefficients (residuals) are added to the inter predicted values that are stored in the frame buffer. The benefit is that correlation between wavelet coefficients of adjacent frames is greater than the correlation between the corresponding quantized coefficients, which results in additional coding efficiency gains. However, the inverse quantization process was initially implemented as floating point operations, which are known to produce results that are operation order and platform implementation dependent. As the reconstructed wavelet coefficients are stored in the frame buffer for inter prediction, the floating-point operations may result in different reconstructed wavelet coefficients at the encoder and decoder if the implementation differs.

FIG. 12 is a functional diagram illustrating decoder 1200. In the example of FIG. 12, arithmetic decoder 1202 performs context-based arithmetic decoding of a displacement bitstream based on a context provided by context update unit 1204. De-binarization unit 1206 de-binarizes the context decoded bitstream to determine values for syntax elements, and coefficient level decoder 1208 performs coefficient level decoding on the syntax elements. Inverse quantization unit 1210 invers quantizes the coefficient levels to determine dequantized coefficients. For intra coded displacements, inverse wavelet transform unit 1214 applies an inverse wavelet transform to the de-quantized coefficient levels to determine the displacements. For inter coded displacements, inter prediction unit 1216 perform inter prediction using reference frames stored in a frame buffer 1218, and adder 1220 adds the prediction values to the dequantized coefficient levels to determine final dequantized coefficient levels. Inverse wavelet transform unit 1214 then inverse transforms the final de-quantized coefficient levels to determine the displacements.

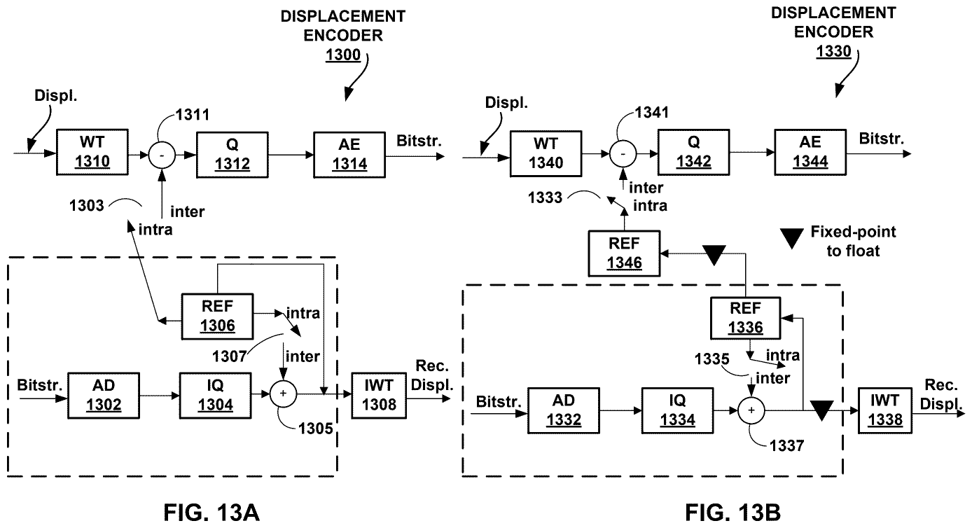

Therefore, as proposed in U.S. patent application Ser. No. 19/013,855, filed 8 Jan. 2025 and Geert Van der Auwera, Adarsh Krishnan Ramasubramonian, Reetu Hooda, Anique Akhtar, Marta Karczewicz, “[V-DMC][EE4.7 Test5-related] V-DMC Displacement Wavelet Coefficient Inter Prediction with Fixed-Point Quantization,” ISO/IEC JTC1/SC29/WG7, m66302, January 2024, both incorporated herein by reference the fixed-point inverse quantizer is integrated to mitigate the potential drift problem due to floating point operations in the inverse quantizer process as illustrated in FIGS. 13A and 13B.

FIG. 13A illustrates an example floating-point implementation of a displacement encoder 1300. Wavelet transform unit (WT) 1310 receives displacement vectors and applies a wavelet transform to the displacement vectors. When selector 1303 is set to an inter-coding mode, subtractor 1311 subtracts a predictor received from reference buffer (REF) 1306 from the transformed coefficients. When selector 1303 is set to an intra-coding mode, subtractor 1311 does not subtract a predictor received from reference buffer (REF) 1306, or equivalently subtracts zero, from the transformed coefficients. Quantization unit (Q) 1312 quantizes the resulting transform coefficeints. Arithmetic encoder (AE) 1314 encodes the quantized transform coefficients into a bitstream (Bitstr.).

To maintain synchronization with a decoder, displacement encoder 1300 includes a local decoding loop (shown by the box in dashed lines). Arithmetic decoder (AD) 1302 decodes the bitstream output by arithmetic encoding unit 1314 to determine quantized residuals. Inverse quantization unit (IQ) 1304 inverse quantizes the quantized residuals. When selector 1307 is set to inter mode, adder 1305 adds a fixed-point predictor received from reference buffer 1306 to the fixed-point dequantized coefficients to generate a reconstructed wavelet coefficient. When selector 1307 is set to intra mode, adder 1305 does not add a fixed-point predictor received from reference buffer 1306, or equivalently, adds zero to the fixed-point dequantized coefficients to generate a reconstructed wavelet coefficient. Reference buffer 1306 stores these reconstructed wavelet coefficients for use in predicting future frames of wavelet coefficients. A displacement decoder of a VDM-decoding device may also include inverse wavelet transform unit (IWT) 1308, which transforms the reconstructed wavelet coefficients to generate reconstructed displacements.

FIG. 13B illustrates an example fixed-point implementation of displacement encoder 1330. Wavelet transform unit (WT) 1340 receives displacement vectors and applies a wavelet transform to the displacement vectors. When selector 1333 is set to an inter-coding mode, subtractor 1341 subtracts a predictor received from reference buffer (REF) 1346 from the transformed coefficients. When selector 1333 is set to an intra-coding mode, subtractor 1341 does not subtract a predictor received from reference buffer (REF) 1346, or equivalently subtracts zero, from the transformed coefficients. Quantization unit (Q) 1342 quantizes the resulting residuals. Arithmetic encoding (AE) unit 1344 encodes the quantized residuals into a bitstream (Bitstr.).

Displacement encoder 1330 includes a local decoding loop (shown by the box in dashed lines) configured to operate using fixed-point arithmetic to maintain synchronization with a decoder and prevent drift associated with floating-point operations. Arithmetic decoder (AD) 1332 decodes the bitstream output by arithmetic encoding unit 1344 to generate quantized residuals. In this fixed-point implementation, arithmetic decoder 1332 outputs integer type residuals. Inverse quantization unit (IQ) 1334 receives the integer residuals and performs a fixed-point inverse quantization process. Inverse quantization unit 1334 may convert the integer residuals to fixed-point values, for example, by performing a left bit shift operation. Inverse quantization unit 1334 multiplies the fixed-point values by an inverse scale factor to determine fixed-point dequantized coefficients. When selector 1335 is set to inter mode, adder 1337 adds a fixed-point predictor received from reference buffer 1336 to the fixed-point dequantized coefficients to generate a reconstructed wavelet coefficient. When selector 1335 is set to intra mode, adder 1337 does not add a fixed-point predictor received from reference buffer 1336, or equivalently, adds zero to the fixed-point dequantized coefficients to generate a reconstructed wavelet coefficient. Reference buffer 1336 stores the reconstructed wavelet coefficient in fixed-point format for use in inter-prediction of subsequent frames. Reference buffer 1336 provides the fixed-point predictors to subtractor 1341 in the forward path and to adder 1337 in the local decoding loop. A converter converts the fixed-point reconstructed wavelet coefficients to floating-point format. A displacement decoder of a VDM-decoding device may also include inverse wavelet transform unit (IWT) 1338, which applies an inverse wavelet transform to the floating-point coefficients to generate the reconstructed displacements.

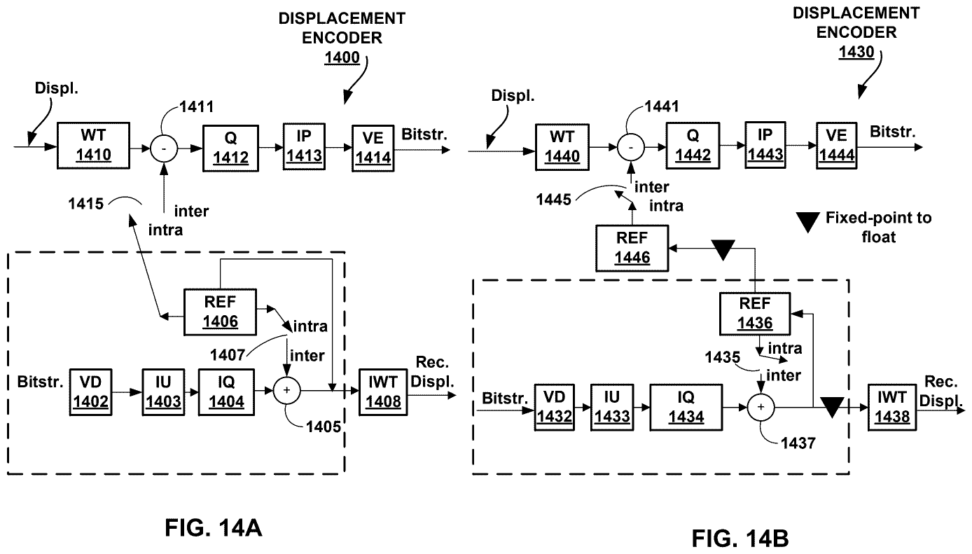

FIG. 14A illustrates an example floating-point implementation of a displacement encoder 1400 utilizing video-based coding. Wavelet transform unit (WT) 1410 receives displacement vectors and applies a wavelet transform to the displacement vectors to generate wavelet coefficients. When selector 1415 is set to an inter-coding mode, subtractor 1411 subtracts a predictor received from reference buffer (REF) 1406 from the transformed coefficients. When selector 1415 is set to an intra-coding mode, subtractor 1411 does not subtract a predictor received from reference buffer (REF) 1406, or equivalently subtracts zero, from the transformed coefficients. Quantization unit 1412 quantizes the transform coefficients. Image packing unit (IP) 1413 packs the quantized coefficients into a frame, such as a two-dimensional image. Video encoding (VE) unit 1414 encodes the frame into a bitstream (Bitstr.).

To maintain synchronization with a decoder, displacement encoder 1400 includes a local decoding loop (shown by the box in dashed lines). Video decoding unit (VD) 1402 decodes the bitstream output by video encoding unit 1414 to determine the encoded frame. Image unpacking unit (IU) 1403 unpacks the frame to determine quantized residuals. Inverse quantization unit (IQ) 1404 inverse quantizes the quantized residuals. When selector 1407 is set to inter mode, adder 1405 adds a fixed-point predictor received from reference buffer 1406 to the fixed-point dequantized coefficients to generate a reconstructed wavelet coefficient. When selector 1407 is set to intra mode, adder 1405 does not add a fixed-point predictor received from reference buffer 1406, or equivalently, adds zero to the fixed-point dequantized coefficients to generate a reconstructed wavelet coefficient. Reference buffer 1406 stores the reconstructed wavelet coefficients for use in predicting future frames of wavelet coefficients. A displacement decoder of a VDM-decoding device may also include inverse wavelet transform unit (IWT) 1408, which transforms the reconstructed wavelet coefficients to generate reconstructed displacements.

FIG. 14B illustrates an example fixed-point implementation of displacement encoder 1430 utilizing video-based coding. Wavelet transform unit 1440 applies a wavelet transform to input displacement vectors to generate wavelet coefficients. When selector 1445 is set to an inter-coding mode, subtractor 1441 subtracts a predictor received from reference buffer (REF) 1446 from the transformed coefficients. When selector 1445 is set to an intra-coding mode, subtractor 1441 does not subtract a predictor received from reference buffer 1446, or equivalently subtracts zero, from the transformed coefficients. Quantization unit 1442 quantizes the resulting residuals. Image packing unit 1443 packs the quantized residuals into a frame. Video encoding unit 1444 encodes the frame into a bitstream.

Displacement encoder 1430 includes a local decoding loop (shown by the box in dashed lines) configured to operate using fixed-point arithmetic. Video decoding unit 1432 decodes the bitstream output by video encoding unit 1444. Image unpacking unit 1433 unpacks the frame to determine quantized residuals. Inverse quantization unit 1434 performs a fixed-point inverse quantization process to determine fixed-point dequantized coefficients. When selector 1435 is set to inter mode, adder 1437 adds a fixed-point predictor received from reference buffer 1436 to the fixed-point dequantized coefficients to generate a reconstructed wavelet coefficient. When selector 1435 is set to intra mode, adder 1437 does not add a fixed-point predictor received from reference buffer 1436, or equivalently, adds zero to the fixed-point dequantized coefficients to generate a reconstructed wavelet coefficient. Reference buffer 1436 stores the reconstructed wavelet coefficient in fixed-point format. Selector 1435 enables selection between an inter mode and an intra mode. Reference buffer 1436 provides the fixed-point predictors to adder 1437. A converter converts the fixed-point reconstructed wavelet coefficients to floating-point format. Inverse wavelet transform unit 1438 applies an inverse wavelet transform to the floating-point coefficients to generate reconstructed displacements. Additionally, a converter converts the fixed-point predictors to floating-point format and provides the floating-point predictors to reference buffer 1446.

Aspects of N01027 will now be described. The following sections reproduce syntax and semantics from the V-DMC DIS of N01027 that are related to the signaling of quantization parameters relevant to the coding of displacement wavelet coefficients (lifting scheme). Aspects of the atlas metadata sub-bitstream of N01027 will now be described, beginning with the atlas sequence parameter set. Syntax elements that are relevant to the quantization process are shown between the delimiters <**> and </**>.

| asps_vdmc_extension( ) { | Descriptor |
|---|---|
| <**>asve_subdivision_iteration_count</**> | u(3) |
| AspsSubdivisionCount = asve_subdivision_iteration_count | |
| if( AspsSubdivisionCount > 1 ) { | |
| asve_lod_adaptive_subdivision_flag | u(1) |
| } | |
| if( AspsSubdivisionCount > 0 ) { | |
| asve_edge_based_subdivision_flag | u(1) |
| } | |
| for( i=0; i < AspsSubdivisionCount ; i++) { | |
| if( asve_lod_adaptive_subdivision_flag == 1 \|\| i == 0 ) { | |
| asve_subdivision_method[ i ] | u(3) |
| } else { | |
| asve_subdivision_method[ i ] = asve_subdivision_method[ 0 ] | |
| } | |
| AspsSubdivisionMethod[ i ] = asve_subdivision_method[ i ] | |
| } | |
| if( asve_edge_based_subdivision_flag == 1 ) { | |
| asve_subdivision_min_edge_length | u(16) |
| AspsSubdivisionMinEdgeLength = asve_subdivision_min_edge_length | |
| } else { | |
| AspsSubdivisionMinEdgeLength = 0 | |
| } | |
| <**>asve_1d_displacement_flag</**> | u(1) |
| asve_interpolate_subdivided_normals_flag | u(1) |
| <**>asve_displacement_reference_qp_minus49</**> | se(v) |
| <**>asve_quantization_parameters_present_flag</**> | u(1) |
| <**>if( asve_quantization_parameters_present_flag ) {</**> | |
| <**>asve_inverse_quantization_offset_present_flag</**> | u(1) |
| <**>vdmc_quantization_parameters( 0, AspsSubdivisionCount, 0) </**> | |
| } | |
| if( AspsSubdivisionCount != 0 ) { | |
| asve_transform_method | u(3) |
| AspsTransformMethod = asve_transform_method | |
| } | |
| asve_lifting_offset_present_flag | u(1) |
| if( asve_transform_method == LINEAR_LIFTING && AspsSubdivisionCo | |
| unt != 0 ) { | |
| asve_directional_lifting_present_flag | u(1) |
| vdmc_lifting_transform_parameters( 0, AspsSubdivisionCount ) | |
| } | |
| asve_attribute_information_present_flag | u(1) |
| if( asve_attribute_information_present_flag ) { | |
| asve_consistent_attribute_frame_flag | u(1) |
| if(!asve_consistent_attribute_frame_flag) { | |
| asve_attribute_frame_count | u(7) |
| } | |
| for(i=0; i< AspsAttributeNominalFrameCount; i++){ | |
| asve_attribute_frame_width[ i ] | ue(v) |
| asve_attribute_frame_height[ i ] | ue(v) |
| asve_attribute_subtexture_enabled_flag[ i ] | u(1) |
| } | |
| } | |
| <**>asve_displacement_id_present_flag</**> | u(1) |
| asve_lod_patches_enable_flag | u(1) |
| asve_packing_method | u(1) |
| if ( !asve_attribute_information_present_flag ) { | |
| asve_projection_texcoord_enable_flag | u(1) |
| if( asve_projection_texcoord_enable_flag ){ | |
| asve_projection_texcoord_mapping_attribute_index_present_flag | u(1) |
| if( asve_projection_texcoord_mapping_attribute_index_present_flag ) { | |
| asve_projection_texcoord_mapping_attribute_index | u(7) |
| } | |
| asve_projection_texcoord_output_bit_depth_minus1 | u(5) |
| asve_projection_texcoord_bbox_bias_enable_flag | u(1) |
| asve_projection_texcoord_upscale_factor_minus1 | u(40) |
| asve_projection_texcoord_log2_downscale_factor | u(6) |
| asve_projection_raw_textcoord_present_flag | u(1) |
| if( asve_projection_raw_textcoord_present_flag ) | |
| asve_projection_raw_textcoord_bitdepth_minus1 | u(v) |
| } | |
| } | |
| asve_vdmc_vui_parameters_present_flag | u(1) |
| if( asve_vdmc_vui_parameters_present_flag ) | |
| vdmc_vui_parameters( ) | |
| } | |

asve_subdivision_iteration_count indicates the number of iterations used for the subdivision.
asve_1d_displacement_flag equal to 1 specifies that only a single component of the displacement is present in the geometry bitstream. The remaining two components are inferred to be 0. asve_1d_displacement_flag equal to 0 specifies that all three components of the displacement are present in the geometry bitstream. The following variable is defined:

$$AspsDispComponents = asve\_Id \_displacement \_flag ? 1 : 3$$

asve_displacement_reference_qp_minus49 plus 49 specifies the initial value of QuantizationParameter for current frame. The value of asve_displacement_reference_qp_minus49 shall be in the range of −48 to +51, inclusive. When not present asve_displacement_reference_qp_minus49 is set to be equal to 0.
asve_quantization_parameters_present_flag equal to 1 specifies that the vdmc_quantization_parameters( ) syntax structure is present.
asve_quantization_parameters_present_flag equal to 0 specifies that the vdmc_quantization_parameters( ) syntax structure is not present.
asve_inverse_quantization_offset_present_flag equal to 1 specifies that the inverse quantization offset is present for compensating the inverse quantized wavelet-transformed coefficients of the displacement. asve_inverse_quantization_offset_present_flag equal to 0 specifies that the inverse quantization offset is not present.

### AspsInvQuantOffsetPresentFlag=asve_inverse_quantization_offset_present_flag

asve_displacement_id_present_flag equal to 1 specifies that the displacement data ID is signalled in the meshpatch data unit and 2D bounding box associated with displacement is not signalled in the meshpatch data unit. asve_displacement_id_present_flag equal to 0 specifies that the displacement data ID is not signalled in the meshpatch data unit and the 2D bounding box associated with displacement is signalled in the meshpatch data unit.

### AspsDisplacementIdPresentFlag=asve_displacement_id_present_flag

The vdmc_quantization_parameters structure is shown below:

| vdmc_quantization_parameters( qpIndex, subdivisionCount, refSubdivisionCount ){ | Descriptor |
|---|---|
| vqp_lod_quantization_flag[ qpIndex ] | u(1) |
| if( vqp_lod_quantization_flag[ qpIndex ] == 0 ) { | |
| for( k = 0; k < AspsDispComponents; k++ ) { | |
| vqp_quantization_parameter[ qpIndex ][ k ] | u(7) |
| for( i=0 ; i < subdivisionCount + 1; i++) | |
| QuantizationParameter[ qpIndex ][ i ][ k ] = | |
| vqp_quantization_parameter[ qpIndex ][ k ] | |
| vqp_log2_lod_inverse_scale[ qpIndex ][ k ] | u(2) |
| } | |
| } else { | |
| for( i=0 ; i < subdivisionCount + 1; i++ ) { | |
| for( k = 0; k < AspsDispComponents; k++ ) { | |
| vqp_lod_delta_quantization_parameter_value[ qpIndex ][ i ][ k ] | ue(v) |
| if( vqp_lod_delta_quantization_parameter_value[ qpIndex ][ i ][ k ] ) | |
| vqp_lod_delta_quantization_parameter_sign[ qpIndex ][ i ][ k ] | u(1) |
| if( qpIndex = 0 ) { | |
| QuantizationParameter[ qpIndex ][ i ][ k ] = | |
| asve_displacement_reference_qp_minus49 + 49 + ( 1 − 2 * | |
| vqp_lod_delta_quantization_parameter_sign[ qpIndex ][ i ][ k ] ) * | |
| vqp_lod_delta_quantization_parameter_value[ qpIndex ][ i ][ k ] | |
| } else if( subdivisionCount <= refSubdivisionCount ) { | |
| QuantizationParameter[ qpIndex ][ i ][ k ] = | |
| QuantizationParameter[ qpIndex − 1 ][ i ][ k ] + ( 1 − 2 * | |
| vqp_lod_delta_quantization_parameter_sign[ qpIndex ][ i ][ k ] ) * | |
| vqp_lod_delta_quantization_parameter_value[ qpIndex ][ i ][ k ] | |
| } else { | |
| QuantizationParameter[ qpIndex ][ i ][ k ] = | |
| QuantizationParameter[ qpIndex − 1 ][ 0 ][ k ] + ( 1 − 2 * | |
| vqp_lod_delta_quantization_parameter_sign[ qpIndex ][ i ][ k ] ) * | |
| vqp_lod_delta_quantization_parameter_value[ qpIndex ][ i ][ k ] | |
| } | |
| } | |
| } | |
| } | |
| vqp_direct_quantization_enabled_flag[ qpIndex ] | u(1) |
| if ( vqp_direct_quantization_enabled_flag[ qpIndex ] ) | |
| vqp_bitdepth_offset[ qpIndex ] | se(v) |
| } | |

vqp_lod_quantization_flag[qpIndex] equal to 1 indicates that the quantization parameter will be sent per level-of-detail using delta coding. vqp_lod_quantization_flag[qpIndex] equal to 0 indicates that the quantization parameter will be the same for all level-of-details. qpIndex is the index of the quantization parameter set.
vqp_quantization_parameter[qpIndex][k] indicates the quantization parameter to be used for the inverse quantization of the k^{th}-component of the displacements. The value of vqp_quantization_parameter[qpIndex][k] shall be in the range of 0 to 100, inclusive. qpIndex is the index of the quantization parameter set.
vqp_log2_lod_inverse_scale[qpIndex][k] indicates the scaling factor applied to the quantization process of the k^{th}-component of the displacements for each level of detail. qpIndex is the index of the quantization parameter set.
vqp_lod_delta_quantization_parameter_value[qpIndex][i][k] specifies the absolute difference of quantization parameter value between the value asve_displacement_reference_qp_minus49+49 (when qpIndex is equal to 0) or the reconstructed QuantizationParameter [qpIndex−1][i][k] (when qpIndex is larger than 0) and the quantization parameter for the i^{th}-layer and k^{th}-component. When not present, the value of vqp_lod_delta_quantization_parameter_value[qpIndex][i][k] is inferred as 0. The value of QuantizationParameter of each LoD layer shall be in the range of 0 to 100. qpIndex is the index of the quantization parameter set.
vqp_lod_delta_quantization_parameter_sign[qpIndex][i][k] specifies the sign of difference of quantization parameter value between the value asve_displacement_reference_qp_minus49+49 and the quantization parameter for the i^{th}-layer and k^{th}-component. vqp_lod_delta_quantization_parameter_sign[qpIndex][i][k] equal to 0 indicate the difference is positive. vqp_lod_delta_quantization_parameter_sign[qpIndex][i][k] equal to 1 indicate the difference is negative. When not present, the value of vqp_lod_delta_quantization_parameter_sign[qpIndex][i][k] is inferred as 0. qpIndex is the index of the quantization parameter set.
vqp_direct_quantization_enabled_flag[qpIndex] equal to 1 indicates that the inverse scale factor is derived from the signaled displacement quantization parameter directly. qpIndex is the index of the quantization parameter set.
vqp_bitdepth_offset[qpIndex] indicates the bit depth offset value applied to the quantization process of the displacements, qpIndex is the index of the quantization parameter set.

Aspects of the atlas frame parameter set in N01027 will now be described. Syntax elements that are relevant to the quantization process are shown between the delimiters <**> and </**>.

| afps_vdmc_extension( ) { | Descriptor |
|---|---|
| AfpsSubdivisionCount = AspsSubdivisionCount | |
| AfpsTransformMethod = AspsTransformMethod | |
| afve_override_flag | u(1) |
| if( afve_override_flag ) { | |
| afve_subdivision_iteration_count_present_flag | u(1) |
| if( afve_subdivision_iteration_count_present_flag ) { | |
| afve_subdivision_iteration_count | u(3) |
| AfpsSubdivisionCount = afve_subdivision_iteration_count | |
| } | |
| if( AfpsSubdivisionCount != 0 ) | |
| afve_transform_method_present_flag | u(1) |
| if( !afve_subdivision_iteration_count_present_flag ) { | |
| if( AfpsSubdivisionCount != 0 ) | |
| afve_subdivision_method_present_flag | u(1) |
| <**>if( asve_quantization_parameters_present_flag ) </**> | |
| <**>afve_quantization_parameters_present_flag</**> | u(1) |
| if( ( !afve_transform_method_present_flag ) && AfpsSubdivisionCount | |
| != 0 ) ) | |
| afve_transform_parameters_present_flag | u(1) |
| } | |
| } | |
| if( afve_subdivision_method_present_flag ) { | |
| if( AfpsSubdivisionCount > 1) { | |
| afve_lod_adaptive_subdivision_flag | u(1) |
| } | |
| for( i=0; i < AfpsSubdivisionCount ; i++ ) { | |
| if( afve_lod_adaptive_subdivision_flag == 1 \|\| i == 0 ) { | |
| afve_subdivision_method[ i ] | u(3) |
| } else { | |
| afve_subdivision_method[ i ] = afve_subdivision_method[ 0 ] | |
| } | |
| AfpsSubdivisionMethod[ i ] = afve_subdivision_method[ i ] | |
| } | |
| if( asve_edge_based_subdivision_flag == 1 ) { | |
| afve_subdivision_min_edge_length | u(16) |
| AfpsSubdivisionMinEdgeLength = afve_subdivision_min_edge_length | |
| } else { | |
| AfpsSubdivisionMinEdgeLength = 0 | |
| } | |
| } else { | |
| for( i = 0; i < AfpsSubdivisionCount; i++ ){ | |
| AfpsSubdivisionMethod[ i ] = AspsSubdivisionMethod[ i ] | |
| } | |
| AfpsSubdivisionMinEdgeLength = AspsSubdivisionMinEdgeLength | |
| } | |
| <**>if( afve_quantization_parameters_present_flag ) </**> | |
| <**>vdmc_quantization_parameters( 1, AfpsSubdivisionCount, AspsS | |
| ubdivisionCount ) </**> | |
| if( afve_transform_method_present_flag && ( AfpsSubdivisionCount != | |
| 0 ) ) { | |
| afve_transform_method | u(3) |
| AfpsTransformMethod = afve_transform_method | |
| } | |
| if( afve_transform_method == | |
| LINEAR_LIFTING && afve_transform_parameters_present_flag) { | |
| vdmc_lifting_transform_parameters( 1, AfpsSubdivisionCount ) | |
| } | |
| if( asve_attribute_information_present_flag ) { | |
| if( AspsAttributeNominalFrameCount > 1 ) | |
| afve_consistent_tiling_across_attribute_video_flag | u(1) |
| if( afve_consistent_tiling_across_attribute_video_flag ) { | |
| if( AspsAttributeNominalFrameCount > 1 ) | |
| afve_reference_attribute_idx | ue(v) |
| atlas_frame_attribute_tile_information( afve_reference_attribute_idx ) | |
| } else { | |
| for( attrIdx=0; attrIdx< AspsAttributeNominalFrameCount; attrIdx++ ) { | |
| atlas_frame_attribute_tile_information( attrIdx ) | |
| } | |
| } | |
| } | |
| atlas_frame_mesh_information( ) | |
| if( asve_projection_texcoord_enable_flag ) { | |
| for( i = 0;i < NumSubMeshes; i++ ) { | |
| afve_projection_texcoord_present_flag[ i ] | u(1) |
| if( afve_projection_texcoord_present_flag[ i ]) { | |
| afve_projection_texcoord_width_normalization[ i ] | ue(v) |
| afve_projection_texcoord_height_normalization[ i ] | ue(v) |
| afve_projection_texcoord_gutter[ i ] | ue(v) |
| } | |
| } | |
| } | |
| } | |

afve_override_flag equal to 1 indicates the parameters afve_subdivision_iteration_count_present_flag, afve_subdivision_iteration_count, afve_subdivision_method_present_flag, afve_quantization_parameters_present_flag, afve_transform_method_present_flag, and afve_transform_parameters_present_flag are present in the atlas frame parameter set extension.

afve_quantization_parameters_present_flag equal to 1 indicates vdmc_quantization_parameters(qpIndex, subdivisionCount, refSubdivisionCount) syntax structure is present in the atlas frame parameter set extension. afve_quantization_parameters_present_flag equal to 0 indicates vdmc_quantization_parameters (qpIndex, subdivisionCount, refSubdivisionCount) syntax structure is not present in the atlas frame parameter set extension. When afve_quantization_parameters_present_flag is not present, if afve_overridden_flag is equal to 1 and asve_quantization_parameters_present_flag is equal to 0, afve_quantization_parameters_present_flag is inferred to be equal to 0, otherwise if afve_overridden_flag is equal to 1 and asve_quantization_parameters_present_flag is equal to 1 and afve_subdivision_iteration_count_present_flag is equal to 1, afve_quantization_parameters_present_flag is inferred to be equal to 1, otherwise its value is inferred to be equal to 0.

Aspects of the meshpatch data unit in N01027 will now be described. Syntax elements that are relevant to the quantization process are shown between the delimiters <**> and </**>.

| | Descriptor |
|---|---|
| meshpatch_data_unit( tileID, patchIdx ) { | |
| mdu_submesh_id[ tileID ][ patchIdx ] | ue(v) |
| if( ath_type = = P_TILE \|\| ath_type = = I_TILE ) { | |
| <**>if( AspsDisplacementIdPresentFlag ) {</**> | |
| <**>mdu_displ_id[ tileID ][ patchIdx ] </**> | ue(v) |
| } else { | |
| if( AspsLodPatchesEnableFlag ) | |
| mdu_lod_idx[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| } | |
| if( mdu_lod_idx[ tileID ][ patchIdx ] == 0 ) { | |
| PatchSubdivisionCount[ tileID ][ patchIdx ] = AfpsSubdivisionCount | |
| <**>mdu_parameters_override_flag[ tileID ][ patchIdx ] </**> | u(1) |
| if( mdu_parameters_override_flag[ tileID ][ patchIdx ] ){ | |
| mdu_subdivision_iteration_count_present_flag[ tileID ][ patchIdx ] | u(1) |
| if( mdu_subdivision_iteration_count_present_flag[ tileID ][ patchIdx ] ) { | |
| mdu_subdivision_iteration_count | u(3) |
| PatchSubdivisionCount[ tileID ][ patchIdx ] = | |
| mdu_subdivision_iteration_count | |
| } | |
| if( PatchSubdivisionCount[ tileID ][ patchIdx ] != 0 ) | |
| mdu_transform_method_present_flag[ tileID ][ patchIdx ] | u(1) |
| if( !mdu_subdivision_iteration_count_present_flag[ tileID ][ patchIdx ] ) { | |
| if( PatchSubdivisionCount[ tileID ][ patchIdx ] != 0 ) | |
| mdu_subdivision_method_present_flag[ tileID ][ patchIdx ] | u(1) |
| <**>if( asve_quantization_parameters_present_flag ) | |
| </**> | |
| <**>mdu_quantization_present_flag[ tileID ][ patchIdx ] </**> | u(1) |
| if ( ( !mdu_transform_method_present_flag[ tileID ][ patchIdx ] ) && | |
| PatchSubdivisionCount[ tileID ][ patchIdx ] != 0 ) | |
| mdu_transform_parameters_present_flag[ tileID ][ patchIdx ] | u(1) |
| } | |
| } | |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag = = 1 \|\| i = = 0 ) { | |
| mdu_subdivision_method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| if( asve_edge_based_subdivision_flag = = 1 ) { | |
| mdu_subdivision_min_edge_length[ tileID ][ patchIdx ] | u(16) |
| PatchSubdivisionMinEdgeLength[ tileID ][ patchIdx ] = | |
| mdu_subdivision_min_edge_length[ tileID ][ patchIdx ] | |
| } else { | |
| PatchSubdivisionMinEdgeLength[ tileID ][ patchIdx ] = 0 | |
| } | |
| } else { | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| PatchSubdivisionMinEdgeLength[ tileID ][ patchIdx ] = | |
| AfpsSubdivisionMinEdgeLength | |
| } | |
| <**> | |
| if( mdu_quantization_present_flag[ tileID ][ patchIdx ] ) | |
| vdmc_quantization_parameters( 2, | |
| PatchSubdivisionCount[ tileID ][ patchIdx ], | |
| AfpsSubdivisionCount ) | |
| if( AspsInvQuantOffsetPresentFlag ) { | |
| mdu_inverse_quantization_offset_enable_flag[ tileID ][ patchIdx ] | u(1) |
| if( mdu_inverse_quantization_offset_enable_flag ) { | |
| for( i = 0; i < PatchSubdivisionCount[ tileID ][ patchIdx ]; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] | u(1) |
| mdu_inverse_quantization_offset_value_log2_prec1_delta[ tileID ][ patchIdx | se(v) |
| ][ i ][ j ][ k] | |
| mdu_inverse_quantization_offset_value_log2_prec2_delta[ tileID ][ patchIdx | se(v) |
| ][ i ][j ][ k] | |
| } | |
| } | |
| } | |
| } | |
| } | |
| </**> | |
| mdu_displacement_coordinate_system[ tileID ][ patchIdx ] | u(1) |
| if( mdu_transform_method_present_flag[ tileID ][ patchIdx ] && | |
| PatchSubdivisionCount[ tileID ][ patchIdx ] != 0 ) | |
| mdu_transform_method[ tileID ][ patchIdx ] | u(3) |
| if( mdu_transform_method[ tileID ][ patchIdx ] == LINEAR_LIFTING ) { | |
| if( AspsLiftingOffsetPresentFlag ) { | |
| mdu_lifting_offset_present_flag | u(1) |
| [ tileID ][ patchIdx ] | |
| if( mdu_lifting_offset_present_flag[ tileID ][ patchIdx ] ) { | |
| for( i = 0; i < PatchSubdivisionCount[ tileID ][ patchIdx ]; i++ ) { | |
| mdu_lifting_offset_values_num[ tileID ][ patchIdx ][ i ] | se(v) |
| mdu_lifting_offset_values_deno_minus1[ tileID ][ patchIdx ][ i ] | ue(v) |
| } | |
| } | |
| } | |
| if( AspsDirectionalLiftingPresentFlag ) { | |
| for( i = 0; i < 2; i++ ) { | |
| mdu_directional_lifting_scale_num[ tileID ][ patchIdx ][ i ] | se(v) |
| } | |
| } | |
| if ( mdu_transform_parameters_present_flag[ tileID ][ patchIdx ] ) { | |
| vdmc_lifting_transform_parameters(2, | |
| PatchSubdivisionCount[ tileID ][ patchIdx ] ) | |
| } | |
| } | |
| } | |
| if( AspsDisplacementldPresentFlag \|\| (AspsLodPatchesEnableFlag = = | |
| 0 ) ) { | |
| vertexInfoCount = PatchSubdivisionCount[ tileID ][ patchIdx ] + 1 | |
| } else { | |
| vertexInfoCount = 1 | |
| } | |
| for( i = 0; i < vertexInfoCount; i++ ) { | |
| mdu_block_count_minus1[ tileID ][ patchIdx ][ i ]; | u(v) |
| mdu_last_pos_in_block[ tileID ][ patchIdx ][ i ] | u(v) |
| } | |
| smIdx = SubmeshIDToIndex[ mdu_submesh_id[ tileID ][ patchIdx ] ] | |
| if( afve_projection_texcoord_present_flag[ smIdx ] ) | |
| texture_projection_information( tileID, patchIdx ) | |
| } | |
| if( ath_type == P_TILE_ATT \|\|ath_type == I_TILE_ATTR ) { | |
| i = TileIDToAtlasAttributeIdx[ tileID ] | |
| if( AspsAttributeSubtextureEnabledFlag[ i ] ){ | |
| mdu_attributes_2d_pos_x[ tileID ][ patchIdx ] | ue(v) |
| mdu_attributes_2d_pos_y[ tileID ][ patchIdx ] | ue(v) |
| mdu_attributes_2d_size_x_minus1[ tileID ][ patchIdx ] | ue(v) |
| mdu_attributes_2d_size_y_minus1[ tileID ][ patchIdx ] | ue(v) |
| } | |
| } | |
| } | |
| | Descriptor |
| merge_meshpatch_data_unit( tileID, patchIdx ) { | |
| if( NumRefIdxActive ) | |
| mmdu_ref_index[ tileID ][ patchIdx ] | ue(v) |
| mmdu_patch_index[ tileID ][ patchIdx ] | se(v) |
| if( AspsLodPatchesEnableFlag ) | |
| mmdu_lod_idx[ tileID ][ patchIdx ] | ue(v) |
| if( mmdu_lod_idx[ tileID ][ patchIdx ] = = 0 ) { | |
| mmdu_subdivision_iteration_count_present_flag[ tileID ][ patchIdx ] | u(1) |
| if( mmdu_subdivision_iteration_count_present_flag[ tileID ][ patchIdx ] ) | |
| { | |
| mmdu_subdivision_iteration_count[ tileID ][ patchIdx ] | u(3) |
| MergePatchSubdivisionCount[ tileID ][ patchIdx ] = | |
| mmdu_subdivision_iteration_count[ tileID ][ patchIdx ] | |
| } else { | |
| MergePatchSubdivisionCount[ tileID ][ patchIdx ] = AfpsSubdivisionCou | |
| nt | |
| } | |
| <**> | |
| if( AspsInvQuantOffsetPresentFlag ) { | |
| mmdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| mmdu_inverse_quantization_offset_sign[ tileID ][ patchidx ][ i ][ j ][ k ] | u(1) |
| mmdu_inverse_quantization_offset_value_log2_prec1_delta[ tileID ][ patchI | se(v) |
| dx ][ i ][ j ][ k] | |
| mmdu_inverse_quantization_offset_value_log2_prec2_delta[ tileID ][ patchI | se(v) |
| dx ][ i ][ j ][ k] | |
| } | |
| } | |
| } | |
| } | |
| } | |
| </**> | |
| if( AspsLiftingOffsetPresentFlag ){ | |
| mmdu_lifting_offset_present_flag[ tileID ][ patchIdx ] | u(1) |
| if( mmdu_lifting_offset_present_flag[ tileID ][ patchIdx ] ) { | |
| for( i = 0; i < MergePatchSubdivisionCount[ tileID ][ patchIdx ]; i++ ) { | |
| mmdu_lifting_offset_delta_values_num[ tileID ][ patchIdx ][ i ] | se(v) |
| mmdu_lifting_offset_delta_values_deno[ tileID ][ patchIdx ][ i ] | se(v) |
| } | |
| } | |
| } | |
| if( AspsDirectionalLiftingPresentFlag ) { | |
| for( i = 0; i < 2; i++ ) { | |
| mmdu_directional_lifting_scale_num[ tileID ][ patchIdx ][ i ] | se(v) |
| } | |
| } | |
| if( asve_projection_texcoord_enable_flag ){ | |
| mmdu_texture_projection_present_flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| | Descriptor |
| inter_meshpatch_data_unit( tileID, patchIdx ) { | |
| if( NumRefIdxActive ) | |
| imdu_ref_index[ tileID ][ patchIdx ] | ue(v) |
| imdu_patch_index[ tileID ][ patchIdx ] | se(v) |
| if( !AspsDisplacementldPresentFlag ) { | |
| if( AspsLodPatchesEnableFlag ) | |
| imdu_lod_idx[ tileID ][ patchIdx ] | ue(v) |
| imdu_2d_delta_pos_x[ tileID ][ patchIdx ] | se(v) |
| imdu_2d_delta_pos_y[ tileID ][ patchIdx ] | se(v) |
| imdu_2d_delta_size_x[ tileID ][ patchIdx ] | se(v) |
| imdu_2d_delta_size_y[ tileID ][ patchIdx ] | se(v) |
| } | |
| if( imdu_lod_idx[ tileID ][ patchIdx ] == 0 ) { | |
| imdu_subdivision_iteration_count_present_flag[ tileID ][ patchIdx ] | u(1) |
| if( imdu_subdivision_iteration_count_present_flag[ tileID ][ patchIdx ] }{ | |
| imdu_subdivision_iteration_count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisionCount | |
| <**> | |
| if( AspsInvQuantOffsetPresentFlag ) { | |
| imdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ]; i++ ) { | |
| for( j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k ] | u(1) |
| imdu_inverse_quantization_offset_value_log2_prec1_delta[ tileID ][ patchIdx | se(v) |
| ][ i ][ j ][ k] | |
| imdu_inverse_quantization_offset_value_log2_prec2_delta[ tileID ][ patchIdx | se(v) |
| ][ i ][ j ][ k ] | |
| } | |
| } | |
| } | |
| } | |
| } | |
| </**> | |
| if( InterPatchSubdivisionCount[ tileID ][ patchIdx ] != 0 ) | |
| imdu_transform_parameters_present_flag[ tileID ][ patchIdx ] | u(1) |
| imdu_transform_method_present_flag[ tileID ][ patchIdx ] | u(1) |
| if( imdu_transform_method_present_flag[ tileID ][ patchIdx ] ) { | |
| imdu_transform_method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = AfpsTransformMethod | |
| } | |
| } | |
| if( AspsDisplacementldPresentFlag \|\| ( AspsLodPatchesEnableFlag = = 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_delta_block_count[ tileID ][ patchIdx ][ i ] | se(v) |
| imdu_delta_last_pos_in_block[ tileID ][ patchIdx ][ i ] | se(v) |
| } | |
| if ( imdu_lod_idx[ tileID ][ patchIdx ] = = 0 ) { | |
| if( InterPatchTransformMethod[ tileID ][ patchIdx ] = = LINEAR_LIFTING | |
| && | |
| AspsLiftingOffsetPresentFlag ){ | |
| imdu_lifting_offset present_flag[ tileID ][ patchIdx ] | u(1) |
| if( imdu_lifting_offset_present_flag[ tileID ][ patchIdx ] ) { | |
| for( i = 0; i < InterPatchSubdivisionCount[ tileID ][ patchIdx ]; i++ ) { | |
| imdu_lifting_offset_delta_values_num[ tileID ][ patchIdx ][ i ] | se(v) |
| imdu_lifting_offset_delta_values_deno[ tileID ][ patchIdx ][ i ] | se(v) |
| } | |
| } | |
| } | |
| if( InterPatchTransformMethod[ tileID ][ patchIdx ] = = LINEAR_LIFTING | |
| && | |
| AspsDirectionalLiftingPresentFlag ) { | |
| for( i = 0; i < 2; i++ ) { | |
| imdu_directional_lifting_scale_num[ tileID ][ patchIdx ][ i ] | se(v) |
| } | |
| if( InterPatchTransformMethod[ tileID ][ patchIdx ] == LINEAR_LIFTING | |
| && | |
| ( imdu_transform_parameters_present_flag[ tileID ][ patchIdx ] \|\| | |
| imdu_subdivision_iteration_count_present_flag[ tileID ][ patchIdx ] \|\| | |
| imdu_transform_method_present_flag[ tileID ][ patchIdx ] ) }{ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_texture_projection_present_flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

mdu_displ_id[tileID][patchIdx] indicates the associated displacement ID specified in the current meshpatch with index patchIdx, in the current atlas tile with tile ID equal to tileID. The value of mdu_disp_id[tileID][patchIdx] in the range 0 to 65535, inclusive.
mdu_parameters_override_flag[tileID][patchIdx] equal to 1 indicates the parameters mdu_subdivision_iteration_count_present_flag, mdu_subdivision_iteration_count, mdu_subdivision_method_present_flag, mdu_quantization_present_flag, mdu_transform_method_present_flag, and mdu_transform_parameters_present_flag are present in a meshpatch with index patchIdx, in the current atlas tile, with tile ID equal to tileID. mdu_parameters_override_flag[tileID][patchIdx] equal to 0 indicates that the parameters mdu_subdivision_iteration_count_present_flag, mdu_subdivision_iteration_count, mdu_subdivision_method_present_flag mdu_quantization_present_flag, mdu_transform_method_present_flag, and mdu_transform_parameters_present_flag are not present in a meshpatch with index patchIdx, in the current atlas tile, with tile ID equal to tileID.
mdu_quantization_present_flag[tileID][patchIdx] equal to 1 indicates vdmc_quantization_parameters (qpIndex, subdivisionCount, refSubdivisionCount) syntax structure is present in a meshpatch with index patchIdx, in the current atlas tile, with tile ID equal to tileID. When mdu_quantization_present_flag [tileID][patchIdx] is not present, if mdu_parameters_override_flag is equal to 1 and asve_quantization_parameters_present_flag is equal to 0, its value is inferred to be equal to 0, otherwise if mdu_parameters_override_flag is equal to 1 and asve_quantization_parameters_present_flag is equal to 1 and mdu_subdivision_iteration_count_present_flag is equal to 1, its value is inferred to be equal to 1, otherwise its value is inferred to be equal to 0.

The variable QpIndex for the meshpatch with index patchIdx, in the current atlas tile, with tile ID tileID is derived as follows:

```
QpIndex[ tileID ][ patchIdx ] =
  mdu_quantization_present_flag[ tileID ][ patchIdx ] ? 2 :
  afve_quantization_parameters_present_flag ? 1: 0
```

The variable IQSkip for the current meshpatch with index patchIdx, in the current atlas tile, with tile ID tileID is derived as follows:

```
IQSkip[ tileID ][ patchIdx ] =
  !mdu_quantization_present_flag[ tileID ][ patchIdx ] &&
  !afve_quantization_parameters_present_flag &&
  !asve_quantization_parameters_present_flag
```

mdu_inverse_quantization_offset_enable_flag[tileID][patchIdx] equal to 1 specifies that the inverse quantization offset is used for compensating the inverse quantized wavelet-transformed displacement coefficients of the displacement. mdu_inverse_quantization_offset_enable_flag equal to 0 specifies that the inverse quantization offset is not used. When mdu_inverse_quantization_offset_enable_flag is not present, mdu_inverse_quantization_offset_enable_flag is inferred to be equal to 0.
mdu_inverse_quantization_offset_sign[tileID][patchIdx][i][j][k] indicates the sign of the inverse quantization offset value which is used for compensating the inverse quantized wavelet-transformed displacement coefficients, located in zone k, with displacement dimension j, LoD i, in patch with a meshpatch with index patchIdx, in the current atlas tile, with tile ID equal to tileID. When not present, the value of mdu_inverse_quantization_offset_sign[tileID][patchIdx][i][j][k] is inferred to be equal to 0.
mdu_inverse_quantization_offset_value_log2_prec1_delta[tileID][patchIdx][i][j][k] indicates difference of the values of the inverse quantization offset value for a first precision level located in zone k, with displacement dimension j, between LoD i and LoD i−1 when i is non-zero value, in patch with a meshpatch with index patchIdx, in the current atlas tile, with tile ID equal to tileID. When i is zero, it indicates the absolute value for the offset value for a first precision level associated with LoD 0. When not present, mdu_inverse_quantization_offset_value_log2_prec1_delta[tileID][patchIdx][i][j][k] is inferred to be equal to 0.
mdu_inverse_quantization_offset_value_log2_prec2_delta[tileID][patchIdx][i][j][k] indicates the value of the inverse quantization offset value for a second precision level located in zone k, with displacement dimension j, between LoD i and LoD i−1 when i is non-zero value, in patch with a meshpatch with index patchIdx, in the current atlas tile, with tile ID equal to tileID. When i is zero, it indicates the absolute value for the offset value for a second precision level associated with LoD 0. When not present, mdu_inverse_quantization_offset_value_log2_prec2_delta[tileID][patchIdx][i][j][k] is inferred to be equal to 0.
mmdu_inverse_quantization_offset_enable_flag[tileID][patchIdx] equal to 1 specifies that the inverse quantization offset is used for compensating the inverse quantized wavelet-transformed displacement coefficients of the displacement. mmdu_inverse_quantization_offset_enable_flag equal to 0 specifies that the inverse quantization offset is not used. When mmdu_inverse_quantization_offset_enable_flag is not present, mmdu_inverse_quantization_offset_enable_flag is inferred to be equal to 0.
mmdu_inverse_quantization_offset_sign[tileID][patchIdx][i][j][k] indicates the sign of the inverse quantization offset value which is used for compensating the inverse quantized wavelet-transformed displacement coefficients, located in zone k, with displacement dimension j, LoD i, in patch with a meshpatch with index patchIdx, in the current atlas tile, with tile ID equal to tileID. When not present, the value of mmdu_inverse_quantization_offset_sign[tileID][patchIdx][i][j][k] is inferred to be equal to 0.
mmdu_inverse_quantization_offset_value_log2_prec1_delta[tileID][patchIdx][i][j][k] indicates difference of the values of the inverse quantization offset value for a first precision level located in zone k, with displacement dimension j, between LoD i and LoD i−1 when i is non-zero value, in patch with a meshpatch with index patchIdx, in the current atlas tile, with tile ID equal to tileID. When i is zero, it indicates the absolute value for the offset value for a first precision level associated with LoD 0. When not present, mmdu_inverse_quantization_offset_value_log2 prec1_delta[tileID][patchIdx][i][j][k] is inferred to be equal to 0.
mmdu_inverse_quantization_offset_value_log2_prec2_delta[tileID][patchIdx][i][j][k] indicates the value of the inverse quantization offset value for a second precision level located in zone k, with displacement dimension j, between LoD i and LoD i−1 when i is non-zero value, in patch with a meshpatch with index patchIdx, in the current atlas tile, with tile ID equal to tileID. When i is zero, it indicates the absolute value for the offset value for a second precision level associated with LoD 0. When not present, mmdu_inverse_quantization_offset_value_log2_prec2_delta[tileID][patchIdx][i][j][k] is inferred to be equal to 0.
imdu_inverse_quantization_offset_enable_flag[tileID][patchIdx] equal to 1 specifies that the inverse quantization offset is used for compensating the inverse quantized wavelet-transformed displacement coefficients of the displacement. imdu_inverse_quantization_offset_enable_flag equal to 0 specifies that the inverse quantization offset is not used. When imdu_inverse_quantization_offset_enable_flag is not present, imdu_inverse_quantization_offset_enable_flag is inferred to be equal to 0.
imdu_inverse_quantization_offset_sign[tileID][patchIdx][i][j][k] indicates the sign of the inverse quantization offset value which is used for compensating the inverse quantized wavelet-transformed displacement coefficients, located in zone k, with displacement dimension j, LoD i, in patch with a meshpatch with index patchIdx, in the current atlas tile, with tile ID equal to tileID. When not present, the value of imdu_inverse_quantization_offset_sign[tileID][patchIdx][i][j][k] is inferred to be equal to 0.
imdu_inverse_quantization_offset_value_log2_prec1_delta[tileID][patchIdx][i][j] [k] indicates difference of the values of the inverse quantization offset value for a first precision level located in zone k, with displacement dimension j, between LoD i and LoD i−1 when i is non-zero value, in patch with a meshpatch with index patchIdx, in the current atlas tile, with tile ID equal to tileID. When i is zero, it indicates the absolute value for the offset value for a first precision level associated with LoD 0. When not present, imdu_inverse_quantization_offset_value_log2_prec1_delta [tileID][patchIdx][i][j][k] is inferred to be equal to 0.
imdu_inverse_quantization_offset_value_log2_prec2_delta[tileID][patchIdx][i][j] [k] indicates the value of the inverse quantization offset value for a second precision level located in zone k, with displacement dimension j, between LoD i and LoD i−1 when i is non-zero value, in patch with a meshpatch with index patchIdx, in the current atlas tile, with tile ID equal to tileID. When i is zero, it indicates the absolute value for the offset value for a second precision level associated with LoD 0. When not present, imdu_inverse_quantization_offset_value_log2_prec2_delta[tileID][patchIdx][i][j][k] is inferred to be equal to 0.

Aspects of the arithmetic-coded displacement sub-bitstream will now be described. The following syntax tables are from Annex J of N01027, and syntax elements relevant for quantization are shown between the delimiters <**> and </**>

### Displacement Sequence Parameter Set (DSPS)

| | Descriptor |
|---|---|
| displ_sequence_parameter_set_rbsp( ) { | |
| dsps_sequence_parameter_set_id | u(4) |
| dsps_codec_id | u(8) |
| dsps_profile_tier_level( ) | |
| <**>dsps_single_dimension_flag</**> | u(1) |
| dsps_msb_align_flag | u(1) |
| dsps_log2_max_displ_frame_order_cnt_lsb_minus4 | ue(v) |
| dsps_max_dec_displ_frame_buffering_minus1 | ue(v) |
| dsps_max_num_reorder_frames | ue(v) |
| dsps_max_latency_increase_plus1 | ue(v) |
| dsps_long_term_ref_displ_frames_flag | u(1) |
| dsps_num_ref_displ_frame_lists_in_dsps | ue(v) |
| for( i = 0; i < dsps_num_ref_displ_frame_lists_in_dsps; i++ ) | |
| displ_ref_list_struct( i ) | |
| dsps_geometry_3d_bit_depth_minus1 | u(5) |
| dsps_subdivision_present_flag | u(1) |
| if( dsps_subdivision_present_flag ) { | |
| dsps_subdivision_iteration_count | u(3) |
| DspsSubdivisionCount = dsps_subdivision_iteration_count | |
| } else | |
| DspsSubdivisionCount = 0 | |
| <**>dsps_displacement_reference_qp_minus49</**> | se(v) |
| <**>displ_quantization_parameters( 0, DspsSubdivisionCount, 0) </**> | |
| dsps_extension_present_flag | u(1) |
| if( dsps_extension_present_flag ) { | |
| dsps_extension_count | u(7) |
| } | |
| if( bmsps_extension_count ){ | |
| dsps_extensions_length_minus1 | ue(v) |
| for( i = 0; i < dsps_extension_count; i++ ) { | |
| dsps_extension_type[ i ] | u(8) |
| dsps_extension_length[ i ] | u(16) |
| dsps_extension( dsps_extension_type[ i ], dsps_extension_length[ i ] ) | |
| } | |
| } | |
| rbsp_trailing_bits( ) | |
| } | |

dsps_single_dimension_flag indicates the number of dimensions for the displacements associated with the displacements, dsps_single_dimension_flag equal to 0 indicates three components for the displacements are used. dsps_single_dimension_flag equal to 1 indicates only normal component for the displacements is used. The variable MaxDimension is derived as follows:

$$MaxDimension = dsps\_single \_dimension \_flag ? 1 : 3$$

dsps_displacement_reference_qp_minus49 plus 49 specifies the initial value of DqpQuantizationParameter for current frame. The value of asve_displacement_reference_qp_minus49 shall be in the range of −48 to +51, inclusive. When not present dsps_displacement_reference_qp_minus49 is set to be equal to 0.

| | Descriptor |
|---|---|
| displ_quantization_parameters( qpIndex, subdivisionCount, refSubdivisionCount) | |
| { | |
| dqp_lod_quantization_flag[ qpIndex ] | u(1) |
| dqp_bitdepth_offset[ qpIndex ] | se(v) |
| if( dqp_lod_quantization_flag[ qpIndex ] = = 0 ) { | |
| for( k = 0; k < MaxDimension; k++) { | |
| dqp_quantization_parameters[ qpIndex ][ k ] | u(7) |
| for( i=0 ; i < subdivisionCount + 1; i++ ) | |
| DqpQuantizationParameter[ qpIndex ][ i ][ k ] = | |
| dqp_quantization_parameters[ qpIndex ][ k ] | |
| dqp_log2_lod_inverse_scale[ qpIndex ][ k ] | u(2) |
| } | |
| } else { | |
| for( i=0 ; i < subdivisionCount + 1; i++ ) { | |
| for( k = 0; k < MaxDimension; k++ ) { | |
| dqp_lod_delta_quantization_parameter_value[ qpIndex ][ i ][ k ] | ue(v) |
| if( dqp_lod_delta_quantization_parameter_value[ qpIndex ][ i ][ k ] ) | |
| dqp_lod_delta_quantization_parameter_sign[ qpIndex ][ i ][ k ] | u(1) |
| if( qpIndex = 0 ) { | |
| DqpQuantizationParameter[ qpIndex ][ i ][ k ] = | |
| dsps_displacement_reference_qp_minus49 + 49+ ( 1 − 2* | |
| dqp_lod_delta_quantization_parameter_sign[ qpIndex ][ i ][ k ] ) * | |
| dqp_lod_delta_quantization_parameter_value[ qpIndex ][ i ][ k ] | |
| } else if( subdivisionCount <= refSubdivisionCount) { | |
| DqpQuantizationParameter[ qpIndex ][ i ][ k ] = | |
| DqpQuantizationParameter[ qpIndex − 1 ][ i ][ k ] + ( 1 − 2 * | |
| dqp_lod_delta_quantization_parameter_sign[ qpIndex ][ i ][ k ] ) * | |
| dqp_lod_delta_quantization_parameter_value[ qpIndex ][ i ][ k ] | |
| } else { | |
| DqpQuantizationParameter[ qpIndex ][ i ][ k ] = | |
| DqpQuantizationParameter[ qpIndex − 1 ][ 0 ][ k ] + ( 1 − 2 * | |
| dqp_lod_delta_quantization_parameter_sign[ qpIndex ][ i ][ k ] ) * | |
| dqp_lod_delta_quantization_parameter_value[ qpIndex ][ i ][ k ] | |
| } | |
| } | |
| } | |
| } | |
| } | |

dqp_lod_quantization_flag[qpIndex] equal to 1 indicates that the quantization parameter will be sent per level-of-detail using delta coding. dqp_lod_quantization_flag[qpIndex] equal to 0 indicates that the quantization parameter will be the same for all level-of-details. qpIndex is the index of the quantization parameter set.
dqp_bitdepth_offset[qpIndex] indicates the bit depth offset value applied to the inverse quantization process of the displacements, qpIndex is the index of the quantization parameter set.
dqp_quantization_parameters[qpIndex][k] indicates the quantization parameter to be used for the inverse quantization of the kth-component of the displacements. The value of dqp_quantization_parameters[qpIndex][k] shall be in the range of 0 to 100, inclusive. qpIndex is the index of the quantization parameter set.
dqp_log2_lod_inverse_scale[qpIndex][k] indicates the scaling factor applied to the kth-component of the displacements for each level of detail. qpIndex is the index of the quantization parameter set.
dqp_lod_delta_quantization_parameter_value[qpIndex][i][k] specifies the absolute difference of quantization parameter value between the value dsps_displacement_reference_qp_minus49+49 and the quantization parameter for the ith-layer and kth-component. When not present, the value of dqp_lod_delta_quantization_parameter_value[qpIndex][i][k] is inferred as 0. qpIndex is the index of the quantization parameter set. The value of DqpQuantizationParameter of each LoD layer shall be in the range of 0 to 100.
dqp_lod_delta_quantization_parameter_sign[qpIndex][i][k] specifies the sign of difference of quantization parameter value between the value dsps_displacement_reference_qp_minus49+49 and the quantization parameter for the ith-layer and kth-component. dqp_lod_delta_quantization_parameter_sign[qpIndex][i][k] equal to 0 indicate the difference is positive. dqp_lod_delta_quantization_parameter_sign[qpIndex][i][k] equal to 1 indicate the difference is negative. When not present, the value of dqp_lod_delta_quantization parameter_sign[qpIndex][i][k] is inferred as 0. qpIndex is the index of the quantization parameter set.

Aspects of the displacement frame parameter set (DFPS) in N01027 will now be described.

| | Descriptor |
|---|---|
| displ_frame_parameter_set_rbsp( ) { | |
| dfps_displ_sequence_parameter_set_id | ue(v) |
| dfps_displ_frame_parameter_set_id | ue(v) |
| displ_information( ) | |
| dfps_output_flag_present_flag | u(1) |
| dfps_num_ref_idx_default_active_minus1 | ue(v) |
| dfps_additional_lt_dfoc_lsb_len | ue(v) |
| <**>dfps_override_flag</**> | u(1) |
| <**>if( dfps_override_flag ) {</**> | |
| dfps_subdivision_iteration_count_enable_flag | u(1) |
| <**>dfps_quantization_parameters_enable_flag</**> | u(1) |
| } | |
| if( dfps_subdivision_iteration_count_enable_flag ) { | |
| dfps_subdivision_iteration_count | u(3) |
| DfpsSubdivisionCount = dfps_subdivision_iteration_count | |
| } else | |
| DfpsSubdivisionCount = DspsSubdivisionCount | |
| <**> | |
| if( dfps_quantization_parameters_enable_flag ) | |
| displ_quantization_parameters( 1, DfpsSubdivisionCount, DspsSubdivisi | |
| onCount ) | |
| </**> | |
| dfps_extension_present_flag | u(1) |
| if( dfps_extension_present_flag ) | |
| dfps_extension_8bits | u(8) |
| if( dfps_extension_8bits ) | |
| while( more_rbsp_data( ) ) | |
| dfps_extension_data_flag | u(1) |
| rbsp_trailing_bits( ) | |
| } | |

dfps_override_flag equal to 1 indicates the parameters dfps_subdivision_iteration_count_enable_flag and dfps_quantization_parameters_enable_flag are present in the displacement frame parameter set extension.
dfps_quantization_parameters_enable_flag equal to 1 indicates displ_quantization_parameters(qpIndex, subdivisionCount, refSubdivisionCount) syntax structure is present in the displacement frame parameter set extension. dfps_quantization_parameters_enable_flag equal to 0 indicates displ_quantization_parameters (qpIndex, subdivisionCount, refSubdivisionCount) syntax structure is not present in the displacement frame parameter set extension. When dfps_quantization_parameters_enable_flag is not present, its value is inferred to be equal to 0.

Aspects of the displacement data unit syntax in N01027 will now be described.

| | Descriptor |
|---|---|
| displ_data_unit( displID ) { | |
| ddu_lod_count[ displID ] | ae(v) |
| for( i = 0; i < ddu_lod_count[ displID ]; i++ ){ | |
| ddu_vertex_count_lod[ displID ][ i ] | ae(v) |
| DduLevelOfDetailVertexCount[ displID ][ i ] = ddu_vertex_count_lod[ | |
| displID ][ i ] | |
| ddu_lod_split_flag[ displID ][ i ] | ae(1) |
| ddu_num_subblock_lod[ displID ][ i ] | u(8) |
| vertCount[ displID ][ i ] = ddu_vertex_count_lod[ displID ][ i ] | |
| DduTotalVertCount[ displID ] += ddu_vertex_count_lod[ displID ][ i ] | |
| } | |
| for ( k = 0; k < MaxDimension; k++ ){ | |
| for( level = 0; level < ddu_lod_count[ displID ]; level++ ){ | |
| levelBlockSize[ displID ][ level ] = 1 << | |
| log2 ( vertCount[ displID ][ level ] / ( ddu_lod_split_flag[ | |
| displID ][ level ] ? | |
| ddu_num_subblock_lod[ displID ][ level ] : 1 ) ) | |
| for ( block = 0; block < ddu_num_subblock_lod[ level ]; block ++ ){ | |
| ddu_nz_subBlock[ displID ][ k ][ block ] | ae(v) |
| if ( dpdu_nz_subBlock[ displID ][ k ][ block ] | |
| && ddu_lod_split_flag[ displID ][ level ]){ | |
| vStart[ displID ][ level ] = ( level == 0? 0 : | |
| vStart[ displID ][ level − 1 ] + vertCount[ displID ][ level − 1]) | |
| vBlockStart[ displID ][ level ][ block ] = | |
| vStart[ displID ][ level ] + block * levelBlockSize[ displID ][ level ] | |
| vBlockEnd[ displID ][ level ][ block ] = | |
| min( vBlockStart[ displID ][ level ][ block ] + | |
| levelBlockSize[ displID ][ level ], DduTotalVertCount[ displID ] ) | |
| for( v= vBlockStart[ displID ][ level ][ block ]; | |
| v < vBlockEnd[ displID ][ level ][ block ]; v++ ){ | |
| ddu_coeff_abs_level_gt0[ displID ][ v ][ k ] | ae(v) |
| if( ddu_coeff_abs_level_gt0[ displID ][ v ][ k ] ) { | |
| ddu_coeff_abs_level_gt1[ displID ][ v ][ k ] | ae(v) |
| ddu_coeff_sign[ displID ][ v ][ k ] | u(1) |
| if( ddu_coeff_abs_level_gt1[ displID ][ v ][ k ] ) { | |
| ddu_coeff_abs_level_gt2[ displID ][ v ][ k] | ae(v) |
| if( ddu_coeff_abs_level_gt2[ displID ][ v ][ k ] ) { | |
| ddu_coeff_abs_level_gt3[ displID ][ v ][ k ] | ae(v) |
| if( ddu_coeff_abs_level_gt3[ displID ][ v ][ k ]) { | |
| ddu_coeff_abs_level_rem[ displID ][ v ][ k ] | ae(v) |
| } | |
| } | |
| } | |
| } | |
| } | |
| } | |
| } | |
| } | |
| } | |
| } | |

ddu_lod_count[displID] indicates the number of the subdivision levels used for the displacement signalled in the data unit associated with displId displID.
ddu_vertex_count_lod[displID][i] indicates the number of displacements for the i-th level of wavelet transform for the data unit associated with displId displID.

The inverse quantization offset tool was adopted in V-DMC, Chao Cao, Marta Milovanović, “[V-DMC][EE4.7] Report on EE4.7 test 1.1 on LOD-based inverse quantization offset,” ISO/IEC JTC1/SC29/WG7, m67701, April 2024, which is hereby incorporated by reference. The process computes offset values that are applied to the inverse quantized displacement wavelet coefficients. The offset values are signaled at the meshpatch level (intra/inter/merge) per displacement dimension, level-of-detail and per quantization zone (zero, positive, negative quantized value) as illustrated in the syntax tables described above with respect to meshpatch data units.

The following illustrates the decoding method in N01027 (Section 11.2.5 is reproduced here):

“Then, if AtlasFrameVQPInvQuantOffsetEnableFlag[p] is 1, all the elements of the inverse quantized 2D array dispCoeffArray, of size verCoordCount×3, are adjusted by quantization offset values as follows:

```
vcount0 = 0
for( i = 0; i < subdivisionIterationCount + 1; i++ ) {
  vcount1 = levelOfDetailVertexCount[ i ]
  for( v = vcount0; v < vcount1; v++ ) {
    for( j = 0; j < DisplacementDim; j++ ) {
      k = dispCoeffArray[ v ][ j ] = = 0 ? 0 :
        ( dispCoeffArray[ v ][ j ] > 0 ? 1 : 2 )
      invQuantOffsetSign[ i ][ j ][ k ] =
        AtlasFrameVQPInvQuantOffsetSign[ p ][ i ][ j ][ k ]
      invQuantOffsetValuePrec1[ i ][ j ][ k ] =
        AtlasFrameVQPInvQuantOffsetValuePrec1[ p ][ i ][ j ][ k ]
      invQuantOffsetValuePrec2[ i ][ j ][ k ] =
        AtlasFrameVQPInvQuantOffsetValuePrec2[ p ][ i ][ j ][ k ]
      invQuantOffsetValuePrec1[ i ][ j ][ k ] = ( i = = 0 ?
        invQuantOffsetValuePrec1[ i ][ j ][ k ] :
        ( invQuantOffsetValuePrec1[[ i ][ j ][ k ] +
        invQuantOffsetValuePrec1[ i − 1 ][ j ][ k ] ) )
      invQuantOffsetValuePrec2[ i ][ j ][ k ] = ( i = = 0 ?
        invQuantOffsetValuePrec2[ i ][ j ][ k ] :
        ( invQuantOffsetValuePrec2[ i ][ j ][ k ] +
        invQuantOffsetValuePrec2[ i − 1 ][ j ][ k ] ) )
      inverseQuantizationOffsetValue[ i ][ j ][ k ] =
        pow( 2,−invQuantOffsetValuePrec1[ i ][ j ][ k ] ) +
        pow( 2,−invQuantOffsetValuePrec2[ i ][ j ][ k ] ) *
        ( invQuantOffsetSign[ i ][ j ][ k ] == 0 ? 1 : −1 )
      dispCoeffArray[ v ][ j ] +=
      inverseQuantizationOffsetValue[ i ][ j ][ k ]
    }
  }
  vcount0 = vcount1
}”
```

This disclosure recognizes several shortcomings associated with existing techniques and presents potential solutions to these shortcomings. First, the inverse quantization offset tool is only included in the video-coded displacement sub-bitstream of V-DMC and not in the arithmetic coded (AC) displacement sub-bitstream. Second, the inverse quantization offset tool is implemented with floating-point operations, which are operation order and implementation dependent. The AC displacement sub-bitstream includes a fixed-point inverse quantization process and, therefore, it is required that the inverse quantization offset tool is implemented in fixed-point arithmetic as well due to potential inter prediction loop drifts. Third, the inverse quantization offset tool parameter signaling is integrated in the meshpatch data units that are part of the atlas metadata sub-bitstream.

According to some examples of this disclosure, V-DMC encoder 200 and V-DMC decoder 300 may be configured to perform a fixed-point implementation of an inverse quantization offset tool for an AC displacement sub-bitstream.

This disclosure describes techniques that apply arithmetic coding of the displacements or alternative coding methods such as variable length coding, neural network-based coding, etc. It is understood that the multiple coding approaches can be unified with the fixed-point inverse quantizer and reference buffer implementations.

Referencing FIG. 13B, the fixed-point inverse quantization offset tool is inserted after the inverse quantization block as illustrated in the following:

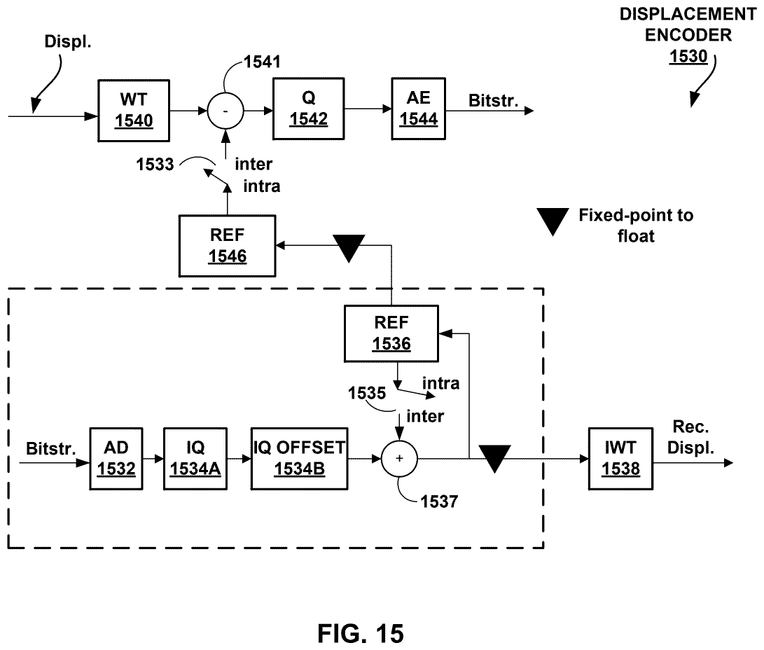

FIG. 15 illustrates an example fixed-point implementation of displacement encoder 1530 utilizing an inverse quantization offset. Wavelet transform unit 1540 receives displacement vectors and applies a wavelet transform to the displacement vectors to generate wavelet coefficients. When selector 1533 is set to an inter-coding mode, subtractor 1541 subtracts a predictor received from reference buffer 1546 from the transformed coefficients. When selector 1533 is set to an intra-coding mode, subtractor 1541 does not subtract a predictor received from reference buffer 1546, or equivalently subtracts zero, from the transformed coefficients. Quantization unit 1542 quantizes the transform coefficients. Arithmetic encoding unit 1544 encodes the quantized transform coefficients into a bitstream.

Displacement encoder 1530 includes a local decoding loop (shown by the box in dashed lines) configured to operate using fixed-point arithmetic to maintain synchronization with a decoder and prevent drift associated with floating-point operations. Arithmetic decoding unit 1532 decodes the bitstream output by arithmetic encoding unit 1544 to generate quantized residuals.

Inverse quantization unit 1534A receives the residuals and performs a fixed-point inverse quantization process to determine fixed-point dequantized coefficients. Inverse quantization offset unit 1534B determines a fixed-point offset value and outputs a set of final wavelet coefficients based on the fixed-point offset value and the set of fixed-point dequantized coefficient values.

When selector 1535 is set to inter mode, adder 1537 adds a fixed-point predictor received from reference buffer 1536 to the adjusted fixed-point coefficients to generate a reconstructed wavelet coefficient. When selector 1535 is set to intra mode, adder 1537 does not add a fixed-point predictor received from reference buffer 1536, or equivalently, adds zero to the adjusted fixed-point coefficients to generate a reconstructed wavelet coefficient. Reference buffer 1536 stores the reconstructed wavelet coefficient in fixed-point format for use in inter-prediction of subsequent frames. A converter converts the fixed-point reconstructed wavelet coefficients to floating-point format. Inverse wavelet transform unit 1538 applies an inverse wavelet transform to the floating-point coefficients to generate reconstructed displacements. Additionally, a converter converts the fixed-point predictors from reference buffer 1536 to floating-point format and provides the floating-point predictors to reference buffer 1546.

In some examples, the conversion from fixed-point to floating point is not performed; all the operations are implemented in the fixed-point domain. In this case, a scaling operation (e.g., multiplication/division, shifting with or without offset) may be performed to match the precision of values. For example, the inverse quantized residuals may be in fixed-point domain with a particular precision P1. The IWT may expect the input to be in a fixed-point representation of a different precision P2. In this case, the precision of the residuals may be converted from P1 to P2 by multiplication/shift left (with or without offset) when P2>P1, or division/shift right (with or without offset) when P2<P1. Similarly changes to precision may be performed in other steps of the coding process.

Both intra and inter coding is supported in these architectures. In inter mode the predictors can be determined from a single reference frame that was decoded prior to the current frame or from multiple references, for example, bi-directional inter prediction. The lifting transform is applied in a hierarchy that results in one or multiple levels of detail (LoD). The inter predictors can be obtained from corresponding LoDs in reference frames on a per sample basis if the order of the vertices in the current and reference frames is identical. If the order is not identical then an index mapping is required. The selection between intra and inter prediction can be determined at the frame level, LoD level, block/segment/submesh level, or sample/coefficient level, etc.

A similar architecture is proposed in E. Myoudou, K. Kishimoto, J. Xu, K. Unno, H. Kato, K. Kawamura, “[V-DMC][EE4.7] Report of EE4.7 Test 1 on porting inverse quantization offset into AC-based displacement coding,” ISO/IEC JTC1/SC29/WG7, m71193, January 2025, incorporated herein by reference.

Given the following implementation of the IQ block in N01027 (Section J.8.5.3 is reproduced here):
Then, all the elements of the 2D array dispCoeffArray, of size verCoordCount×MaxDimension, are initialized as 0. The fixed-point inverse quantization process proceeds as follows:

```
  Vcount0 = 0
    for( i = 0; i < subdivisionCount + 1; i++ ) {
      vcount1 = levelOfDetailVertexCount[ i ]
      for( v = vcount0; v < vcount1; v++ ) {
        for( d = 0; d < MaxDimension; d++ ) {
  dispQuantCoeffArray[ v ][ d ] = dispQuantCoeffArray
  [ v ][ d ] * (1 << 6)
          /* dispQuantCoeffArray contains integer values */
  val = dispQuantCoeffArray[ v ][ d ] * iscale[ i ][ d ]
          dispCoeffArray[ v ][ d ] =
            val < 0 ? −( ( −val + ( 1 << 22 ) ) >> 23 ) :
          ( ( val + ( 1 << 22 ) ) >> 23 )
        }
      }
      vcount0 = vcount1
    }
. . . ”
```

In some examples, the fixed-point inverse quantization offset process (if enabled) is integrated into the fixed-point IQ block as follows (are shown between the delimiters <**> and </**>.

```
):
  Vcount0 = 0
    for( i = 0; i < subdivisionCount + 1; i++ ) {
      vcount1 = levelOfDetailVertexCount[ i ]
      for( v = vcount0; v < vcount1; v++ ) {
        for( d = 0; d < MaxDimension; d++ ) {
  dispQuantCoeffArray[ v ][ d ] = dispQuantCoeffArray[ v ][ d ] * (1 << 6)
            /* dispQuantCoeffArray contains integer values */
          val = dispQuantCoeffArray[ v ][ d ] * iscale[ i ][ d ]
<**>
if (invQuantOffset tool is enabled) {
  z = (dispQuantCoeffArray[ v ][ d ] = = 0) ? 0 : (dispQuantCoeffArray[ v ][ d ] >
  0 ? 1 : 2) /* z determines the quantization zone (zero, positive, negative) */
  offsetSign = invQuantOffsetSign[ i ][ d ][ z ] = = 0 ? 1 : −1
  offsetValue = ( (1 << (23 +6)) >> invQuantOffsetValuePrec1[ i ][ d ][ z] )
      + ( (1 << (23 + 6)) >> invQuantOffset ValuePrec2[ i ][ d ][ z ] )
  /* Note: the values 23 and 6 are related to the particular fixed-point inverse
  quantization method implementation and may have different values or zero */
  offset Value = offsetSign * offsetValue
  val = val + offsetValue
}
</**>
        dispCoeffArray[ v ][ d ] =
                val < 0 ? −( ( −
val + (1 << 22 ) ) >> 23 ) :
  ( ( val + ( 1 << 22 ) ) >> 23 )
              }
            }
            vcount0 = vcount1
          }
```

The parameters invQuantOffsetValuePrec1 and invQuantOffsetValuePrec2 may be positive integer values so that the right bit shift is a defined operation (negative right bit shifts are undefined on certain platforms). The encoder confirms that both parameters are positive integers as follows:

| | |
|---|---|
| ∘ | Determine the first log(2) precision for the fractional part of offset value: |
| | invQuantOffsetValuePrec1 = −floor( log2(offset > 0.0 ? offset : −offset) ) |
| | if invQuantOffsetValuePrec1 < 0, then invQuantOffsetValuePrec1 = 0 |
| ∘ | Determine the second log(2) precision for the fractional part of offset value: |
| | invQuantOffsetValuePrec2 = −floor( log2(offset > 0.0 ? (offset − pow(2, − |

invQuantOffsetValuePrec1)) : (−offset − pow(2, −invQuantOffsetValuePrec1))))

if invQuantOffsetValuePrec2 < 0, then invQuantOffsetValuePrec2 = 0

The encoder clips the invQuantOffsetValuePrec1 and invQuantOffsetValuePrec2 to zero if negative to ensure that only positive integer values are coded in the bitstream.

Similarly, the parameters of the inverse quantization offset tool that is in the V-DMC video-based displacement sub-bitstream in N01027 can be modified to only allow positive integer values for invQuantOffsetValuePrec1 and invQuantOffsetValuePrec2.

The signaling and coding of the inverse quantization offset method is described below.

According to some examples of this disclosure, V-DMC encoder 200 and V-DMC decoder 300 may be configured to signal the inverse quantization offset parameters in the AC displacement sub-bitstream.

The following parameters are coded in the AC displacement sub-bitstream per level-of-detail, displacement dimension, quantization zone (zero, positive, negative):
invQuantOffsetSign: one bit representing sign of the offset value
invQuantOffsetValuePrec1: unsigned integer value representing first log2 precision of the offset value
invQuantOffsetValuePrec2: unsigned integer value representing second log2 precision of the offset value

As is the case for the coding of these corresponding parameters in the atlas metadata sub-bitstream for the meshpatch data unit, delta coding can be applied between zones of level-of-details. Delta decoding proceeds as follows:

```
for( i = 0; i < subdivisionIterationCount + 1; i++ ) {
  for( k = 0; k < 3; k++ ) { /* zone */
    for( j = 0; j < DisplacementDim; j++ ) {
      invQuantOffsetValuePrec1[ i ][ j ][ k ] = ( i = = 0 ?
        invQuantOffsetValuePrec1[ i ][ j ][ k ] :
          ( invQuantOffsetValuePrec1[ i ][ j ][ k ] +
          invQuantOffsetValuePrec1[ i − 1 ][ j ][ k ] ) )
        invQuantOffsetValuePrec2[ i ][ j ][ k ] = ( i = = 0 ?
          invQuantOffsetValuePrec2[ i ][ j ][ k ] :
          ( invQuantOffsetValuePrec2[ i ][ j ][ k ] +
          invQuantOffsetValuePrec2[ i − 1 ][ j ][ k ] ) )
    }
      }
}
```

The parameters may be coded in the DSPS, DFPS, DDU, or quantization syntax described above with respect to arithmetic-coded displacement sub-bitstreams.

It may be a requirement of bitstream conformance that the decoded values of invQuantOffsetValuePrec1 and invQuantOffsetValuePrec2 are greater than or equal to zero.

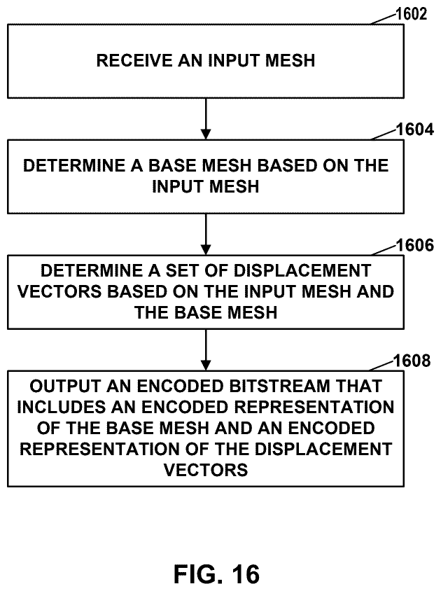

FIG. 16 is a flowchart illustrating an example process for encoding a mesh. Although described with respect to V-DMC encoder 200 (FIGS. 1 and 2), it should be understood that other devices may be configured to perform a process similar to that of FIG. 16.

In the example of FIG. 16, V-DMC encoder 200 receives an input mesh (1602). V-DMC encoder 200 determines a base mesh based on the input mesh (1604). V-DMC encoder 200 determines a set of displacement vectors based on the input mesh and the base mesh (1606). V-DMC encoder 200 outputs an encoded bitstream that includes an encoded representation of the base mesh and an encoded representation of the displacement vectors (1608). V-DMC encoder 200 may additionally determine attribute values from the input mesh and include an encoded representation of the attribute values vectors in the encoded bitstream.

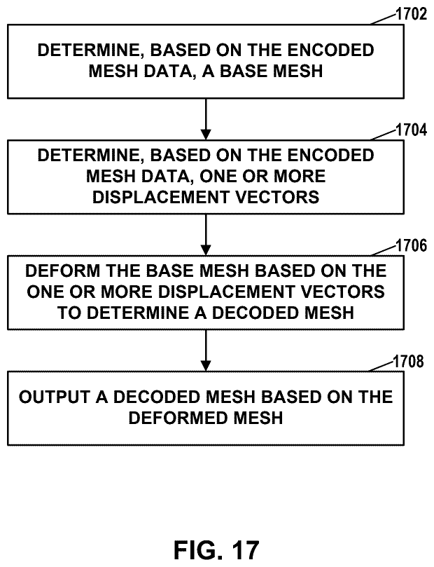

FIG. 17 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 17.

In the example of FIG. 17, V-DMC decoder 300 determines, based on the encoded mesh data, a base mesh (1702). V-DMC decoder 300 determines, based on the encoded mesh data, one or more displacement vectors (1704). V-DMC decoder 300 deforms the base mesh using the one or more displacement vectors (1706). For example, the base mesh may have a first set of vertices, and V-DMC decoder 300 may subdivide the base mesh to determine an additional set of vertices for the base mesh. To deform the base mesh, V-DMC decoder 300 may modify the locations of the additional set of vertices based on the one or more displacement vectors. V-DMC decoder 300 outputs a decoded mesh based on the deformed mesh (1708). V-DMC decoder 300 may, for example, output the decoded mesh for storage, transmission, or display.

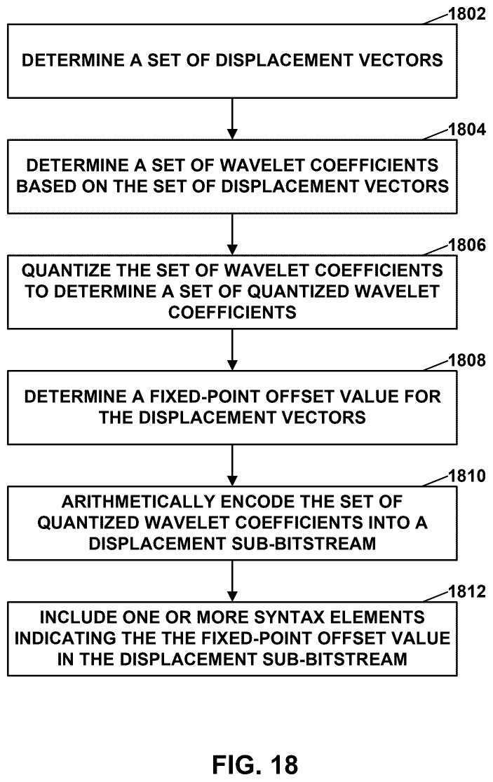

FIG. 18 is a flowchart illustrating an example process for encoding displacement vectors. The techniques of FIG. 18 will be described as being performed by displacement encoder 216 of FIG. 2, although other types of displacement encoders may also implement the techniques of FIG. 18. Displacement encoder 216 determines a set of displacement vectors (1802). Displacement encoder 216 determines a set of wavelet coefficients based on the set of displacement vectors (1804). In some examples, displacement encoder 216 utilizes a lifting scheme to generate the set of wavelet coefficients. Displacement encoder 216 quantizes the set of wavelet coefficients to determine a set of quantized wavelet coefficients (1806).

Displacement encoder 216 determines a fixed-point offset value for the displacement vectors (1808). To determine the fixed-point offset value, displacement encoder 216 may dequantize the set of quantized wavelet coefficients to determine a set of dequantized wavelet coefficients and determine the fixed-point offset value based on a comparison of the set of wavelet coefficients to the set of dequantized wavelet coefficients. Displacement encoder 216 determines the fixed-point offset value per level of detail, per displacement dimension, and per quantization zone. The quantization zone may correspond to a zero zone, a positive zone, or a negative zone based on a value of the quantized wavelet coefficients.

Displacement encoder 216 determines one or more inverse quantization offset parameters to represent the fixed-point offset value. The one or more inverse quantization offset parameters include a sign parameter, a first precision parameter, and a second precision parameter. Displacement encoder 216 determines the first precision parameter, defined as a first log2 precision for a fractional part of the offset value, by calculating a negative floor of a base-2 logarithm of an absolute value of the offset. If the first precision parameter is less than zero, displacement encoder 216 sets the first precision parameter to zero. Displacement encoder 216 determines the second precision parameter, defined as a second log2 precision for the fractional part of the offset value, based on a difference between the absolute value of the offset and a power of two raised to a negative of the first precision parameter. If the second precision parameter is less than zero, displacement encoder 216 sets the second precision parameter to zero. Displacement encoder 216 ensures that the first precision parameter and the second precision parameter are positive integers to ensure defined behavior for bit shift operations.

Displacement encoder 216 arithmetically encodes the set of quantized wavelet coefficients into a displacement sub-bitstream (1810). Displacement encoder 216 includes one or more syntax elements indicating the fixed-point offset value in the displacement sub-bitstream (1812). Displacement encoder 216 signals the sign parameter, the first precision parameter, and the second precision parameter in the displacement sub-bitstream. Displacement encoder 216 may apply delta coding to the first precision parameter and the second precision parameter between quantization zones of levels of detail. By signaling the parameters in the displacement sub-bitstream, displacement encoder 216 enables the displacement sub-bitstream to be self-contained for reconstruction.

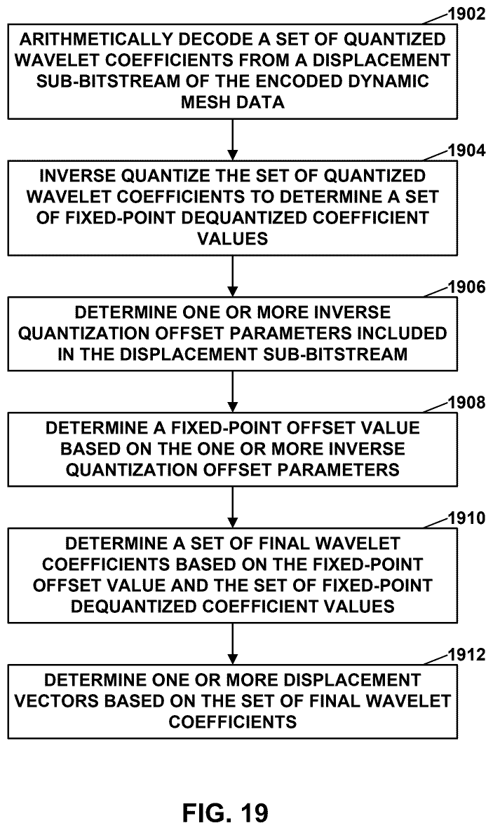

FIG. 19 is a flowchart illustrating an example process for decoding displacement vectors. The techniques of FIG. 19 will be described as being performed by displacement decoder 316 of FIG. 3, although other types of displacement decoders may also implement the techniques of FIG. 19. V-DMC decoder 300 arithmetically decodes a set of quantized wavelet coefficients from a displacement sub-bitstream of the encoded dynamic mesh data (1902). The displacement sub-bitstream may be a self-contained bitstream separate from an atlas metadata sub-bitstream.

V-DMC decoder 300 inverse quantizes the set of quantized wavelet coefficients to determine a set of fixed-point dequantized coefficient values (1904). V-DMC decoder 300 performs this inverse quantization using fixed-point arithmetic to produce integer or fixed-point results.

V-DMC decoder 300 determines one or more inverse quantization offset parameters included in the displacement sub-bitstream (1906). The one or more inverse quantization offset parameters may include a sign parameter (e.g., invQuantOffsetSign), a first precision parameter (e.g., invQuantOffsetValuePrec1), and a second precision parameter (e.g., invQuantOffsetValuePrec2). V-DMC decoder 300 may parse these parameters per level of detail, per displacement dimension, and per quantization zone. In some examples, V-DMC decoder 300 utilizes delta decoding to determine the first precision parameter and the second precision parameter based on values associated with a previous level of detail or a previous quantization zone.

V-DMC decoder 300 determines a fixed-point offset value based on the one or more inverse quantization offset parameters (1908). V-DMC decoder 300 determines a quantization zone (z) for a current coefficient in the set of quantized wavelet coefficients. For example, V-DMC decoder 300 sets z to 0 if the coefficient is zero, sets z to 1 if the coefficient is greater than zero, and sets z to 2 if the coefficient is less than zero. V-DMC decoder 300 selects the inverse quantization offset parameters corresponding to the determined quantization zone.

To calculate the fixed-point offset value, V-DMC decoder 300 may sum a first term and a second term. V-DMC decoder 300 determines the first term by performing a right bit shift operation on a fixed-point constant by an amount indicated by the first precision parameter. V-DMC decoder 300 determines the second term by performing a right bit shift operation on the fixed-point constant by an amount indicated by the second precision parameter. In one example implementation, the fixed-point constant corresponds to a value of one left-shifted by a predetermined bit amount, such as 29 (e.g., 23+6). V-DMC decoder 300 determines an offset sign based on the sign parameter and applies the offset sign to the sum of the first term and the second term to generate the fixed-point offset value.

V-DMC decoder 300 determines a set of final wavelet coefficients based on the fixed-point offset value and the set of fixed-point dequantized coefficient values (1910). V-DMC decoder 300 adds the fixed-point offset value to the fixed-point dequantized coefficient values. By adding the offset value, V-DMC decoder 300 reduces quantization error introduced during an encoding process.

V-DMC decoder 300 determines one or more displacement vectors based on the set of final wavelet coefficients (1912). If the displacement vectors are inter-coded, V-DMC decoder 300 retrieves a set of fixed-point predictors from a reference buffer and adds the set of fixed-point predictors to the set of final wavelet coefficients to generate a set of reconstructed fixed-point coefficients. V-DMC decoder 300 may convert the set of reconstructed fixed-point coefficients into a set of floating-point coefficients. V-DMC decoder 300 applies an inverse wavelet transform to the set of floating-point coefficients to generate the one or more displacement vectors. V-DMC decoder 300 then uses the one or more displacement vectors to deform a base mesh and generate a decoded mesh.

Clause 1A. A method of decoding encoded mesh data, the method comprising: determining, based on the encoded mesh data, a base mesh with a first set of vertices; subdividing the base mesh to determine an additional set of vertices for the base mesh; receiving, in the encoded mesh data, one or more syntax elements indicating an offset value; arithmetically decoding a set of quantized wavelet coefficients; determining one or more displacement vectors based on the set of quantized wavelet coefficients and the offset value; deforming the base mesh to generate a deformed base mesh, wherein deforming the base mesh comprises modifying locations of the additional set of vertices based on the one or more displacement vectors; and determining a decoded mesh based on the deformed base mesh.

Clause 2A. The method of clause 1A, wherein the offset value and the set of quantized wavelet coefficients are fixed-point values.

Clause 3A. The method of clause 1A or 2A, wherein determining the one or more displacement vectors based on the set of quantized wavelet coefficients and the offset value comprises: inverse quantizing the set of quantized wavelet coefficients to determine a set of dequantized wavelet coefficients; adding the offset value to the set of dequantized wavelet coefficients to determine a set of final wavelet coefficients; and determining the one or more displacement vectors based on the set of final wavelet coefficients.

Clause 4A. The method of clause 2A or 3A, wherein determining the one or more displacement vectors based on the set of quantized wavelet coefficients and the offset value further comprises: performing an inverse wavelet transform on the final wavelet coefficients.

Clause 5A. The method of any of clauses 1A-4A, further comprising determining attribute values for vertices of the decoded mesh.

Clause 6A. A device for decoding encoded mesh data, the device comprising: one or more memory units; one or more processing units implemented in circuitry, coupled to the one or more memory units, and configured to perform the method of any of clauses 1A-5A.

Clause 7A. A method of encoding mesh data, the method comprising: determining, based on the encoded mesh data, a base mesh with a first set of vertices; subdividing the base mesh to determine an additional set of vertices for the base mesh; determining one or more displacement vectors for the base mesh; transforming the one or more displacement vectors into a set of coefficients; representing the set of coefficients as an offset value and a set of modified coefficients; quantizing the set of modified coefficients to determine a set of quantized wavelet coefficients; arithmetically encoding the set of quantized wavelet coefficients; including in a bitstream of encoded mesh data, one or more syntax elements indicating the offset value and the encoded set of quantized wavelet coefficients.

Clause 8A. The method of clause 7A, wherein the offset value and the set of quantized wavelet coefficients are fixed-point values.

Clause 9A. A device for encoding encoded mesh data, the device comprising: one or more memory units; one or more processing units implemented in circuitry, coupled to the one or more memory units, and configured to perform the method of clause 7A or 8A.

Clause 1B: A device for decoding a bitstream of encoded dynamic mesh data, the device comprising: at least one memory; and processing circuitry in communication with the at least one memory, the processing circuitry configured to: arithmetically decode a portion of a displacement sub-bitstream of the encoded dynamic mesh data to determine a set of quantized wavelet coefficients; inverse quantize the set of quantized wavelet coefficients to determine a set of fixed-point dequantized coefficient values; determine one or more inverse quantization offset parameters included in the displacement sub-bitstream; determine a fixed-point offset value based on the one or more inverse quantization offset parameters; determine a set of final wavelet coefficients based on the fixed-point offset value and the set of fixed-point dequantized coefficient values; and determine one or more displacement vectors based on the set of final wavelet coefficients; and reconstruct the dynamic mesh data based on the one or more displacement vectors.

Clause 2B: The device of clause 1B, wherein the one or more inverse quantization offset parameters include a sign parameter, a first precision parameter, and a second precision parameter.

Clause 3B: The device of clause 2B, wherein to determine the fixed-point offset value, the processing circuitry is further configured to: determine a first term by performing a right bit shift operation on a fixed-point constant by an amount indicated by the first precision parameter; determine a second term by performing a right bit shift operation on the fixed-point constant by an amount indicated by the second precision parameter; and determine a magnitude of the fixed-point offset value by summing the first term and the second term.

Clause 4B: The device of clause 3B, wherein the fixed-point constant corresponds to a value of one left-shifted by a predetermined bit amount.

Clause 5B: The device of clause 3B or 4B, wherein to determine the fixed-point offset value, the processing circuitry is further configured to: determine an offset sign based on the sign parameter; and apply the offset sign to the magnitude of the fixed-point offset value to determine the fixed-point offset value.

Clause 6B: The device of any of clauses 1B-5B, wherein to determine the one or more inverse quantization offset parameters, the processing circuitry is further configured to: determine a quantization zone based on a value of a coefficient in the set of quantized wavelet coefficients; and select the one or more inverse quantization offset parameters corresponding to the determined quantization zone.

Clause 7B: The device of any of clauses 1B-6B, wherein to determine the one or more displacement vectors, the processing circuitry is further configured to: retrieve a set of fixed-point predictors from a reference buffer; add the set of fixed-point predictors to the set of final wavelet coefficients to generate a set of reconstructed fixed-point coefficients; and determine the one or more displacement vectors based on the set of reconstructed fixed-point coefficients.

Clause 8B: The device of clause 7B, wherein to determine the one or more displacement vectors based on the set of reconstructed fixed-point coefficients, the processing circuitry is further configured to: convert the set of reconstructed fixed-point coefficients into a set of floating-point coefficients; and apply an inverse wavelet transform to the set of floating-point coefficients to determine the one or more displacement vectors.

Clause 9B: The device of any of clauses 1B-8B, wherein the processing circuitry is further configured to: determine a base mesh based on the encoded dynamic mesh data; deform the base mesh based on the one or more displacement vectors to generate a deformed mesh; and output a decoded mesh based on the deformed mesh.

Clause 10B: A method of decoding encoded dynamic mesh data, the method comprising: arithmetically decoding a set of quantized wavelet coefficients from a displacement sub-bitstream of the encoded dynamic mesh data; inverse quantizing the set of quantized wavelet coefficients to determine a set of fixed-point dequantized coefficient values; determining one or more inverse quantization offset parameters included in the displacement sub-bitstream; determining a fixed-point offset value based on the one or more inverse quantization offset parameters; determining a set of final wavelet coefficients based on the fixed-point offset value and the set of fixed-point dequantized coefficient values; and determining one or more displacement vectors based on the set of final wavelet coefficients.

Clause 11B: The method of clause 10B, wherein the one or more inverse quantization offset parameters include a sign parameter, a first precision parameter, and a second precision parameter.

Clause 12B: The method of clause 11B, wherein determining the fixed-point offset value comprises: determining a first term by performing a right bit shift operation on a fixed-point constant by an amount indicated by the first precision parameter; determining a second term by performing a right bit shift operation on the fixed-point constant by an amount indicated by the second precision parameter; and determining a magnitude of the fixed-point offset value by summing the first term and the second term.

Clause 13B: The method of clause 12B, wherein the fixed-point constant corresponds to a value of one left-shifted by a predetermined bit amount.

Clause 14B: The method of clause 12B or 13B, wherein determining the fixed-point offset value comprises: determining an offset sign based on the sign parameter; and applying the offset sign to the magnitude of the fixed-point offset value to generate the fixed-point offset value.

Clause 15B: The method of any of clauses 10B-14B, wherein determining the one or more inverse quantization offset parameters comprises: determining a quantization zone based on a value of a coefficient in the set of quantized wavelet coefficients; and selecting the one or more inverse quantization offset parameters corresponding to the determined quantization zone.

Clause 16B: The method of any of clauses 10B-15B, wherein determining the one or more displacement vectors comprises: retrieving a set of fixed-point predictors from a reference buffer; and adding the set of fixed-point predictors to the set of final wavelet coefficients to generate a set of reconstructed fixed-point coefficients.

Clause 17B: The method of clause 16B, wherein determining the one or more displacement vectors comprises: converting the set of reconstructed fixed-point coefficients into a set of floating-point coefficients; and applying an inverse wavelet transform to the set of floating-point coefficients to generate the one or more displacement vectors.

Clause 18B: The method of any of clauses 10B-17B, further comprising: determining a base mesh based on encoded dynamic mesh data; deforming the base mesh based on the one or more displacement vectors; and outputting a decoded mesh based on the deformed mesh.

Clause 19B: A non-transitory computer-readable medium storing instructions that, when executed by processing circuitry, cause the processing circuitry to: arithmetically decode a set of quantized wavelet coefficients from a displacement sub-bitstream of encoded dynamic mesh data; inverse quantize the set of quantized wavelet coefficients to determine a set of fixed-point dequantized coefficient values; determine one or more inverse quantization offset parameters included in the displacement sub-bitstream; determine a fixed-point offset value based on the one or more inverse quantization offset parameters; determine a set of final wavelet coefficients based on the fixed-point offset value and the set of fixed-point dequantized coefficient values; and determine one or more displacement vectors based on the set of final wavelet coefficients.

Clause 20B: The non-transitory computer-readable medium of clause 19B, wherein the one or more inverse quantization offset parameters include a sign parameter, a first precision parameter, and a second precision parameter.

Clause 21B: The non-transitory computer-readable medium of clause 20B, wherein to determine the fixed-point offset value, the instructions further cause the processing circuitry to: determine a first term by performing a right bit shift operation on a fixed-point constant by an amount indicated by the first precision parameter; determine a second term by performing a right bit shift operation on the fixed-point constant by an amount indicated by the second precision parameter; and determine a magnitude of the fixed-point offset value by summing the first term and the second term.

Clause 22B: The non-transitory computer-readable medium of clause 21B, wherein the fixed-point constant corresponds to a value of one left-shifted by a predetermined bit amount.

Clause 23B: The non-transitory computer-readable medium of clause 21B or 22B, wherein to determine the fixed-point offset value, the instructions further cause the processing circuitry to: determine an offset sign based on the sign parameter; and apply the offset sign to the magnitude of the fixed-point offset value to generate the fixed-point offset value.

Clause 24B: The non-transitory computer-readable medium of any of clauses 19B-23B, wherein to determine the one or more inverse quantization offset parameters, the instructions further cause the processing circuitry to: determine a quantization zone based on a value of a coefficient in the set of quantized wavelet coefficients; and select the one or more inverse quantization offset parameters corresponding to the determined quantization zone.

Clause 25B: The non-transitory computer-readable medium of any of clauses 19B-24B, wherein to determine the one or more displacement vectors, the instructions further cause the processing circuitry to: retrieve a set of fixed-point predictors from a reference buffer; and add the set of fixed-point predictors to the set of final wavelet coefficients to generate a set of reconstructed fixed-point coefficients.

Clause 26B: The non-transitory computer-readable medium of clause 25B, wherein to determine the one or more displacement vectors, the instructions further cause the processing circuitry to: convert the set of reconstructed fixed-point coefficients into a set of floating-point coefficients; and apply an inverse wavelet transform to the set of floating-point coefficients to generate the one or more displacement vectors.

Clause 27B: The non-transitory computer-readable medium of any of clauses 19B-26B, wherein the instructions further cause the processing circuitry to: determine a base mesh based on encoded dynamic mesh data; deform the base mesh based on the one or more displacement vectors; and output a decoded mesh based on the deformed mesh.

Clause 28B: A device for encoding dynamic mesh data, the device comprising: at least one memory; and processing circuitry in communication with the at least one memory, the processing circuitry configured to: determine a set of displacement vectors; determine a set of wavelet coefficients based on the set of displacement vectors; quantize the set of wavelet coefficients to determine a set of quantized wavelet coefficients; determine a fixed-point offset value for the displacement vectors; arithmetically encode the set of quantized wavelet coefficients into a displacement sub-bitstream; and include one or more offset syntax elements indicating the fixed-point offset value in the displacement sub-bitstream.

Clause 29B: The device of clause 28B, wherein to determine the fixed-point offset value for the displacement vectors, the processing circuitry is further configured to: dequantize the set of quantized wavelet coefficients to determine a set of dequantized wavelet coefficients; and determine the fixed-point offset value based on a comparison of the set of wavelet coefficients to the set of dequantized wavelet coefficients.

Clause 30B: The device of clause 28B or 29B, wherein the one or more offset syntax elements include a sign parameter, a first precision parameter, and a second precision parameter.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for decoding a bitstream of encoded dynamic mesh data, the device comprising:
at least one memory; and
processing circuitry in communication with the at least one memory, the processing circuitry configured to:
arithmetically decode a portion of a displacement sub-bitstream of the encoded dynamic mesh data to determine a set of quantized wavelet coefficients;
inverse quantize the set of quantized wavelet coefficients to determine a set of fixed-point dequantized coefficient values;
determine one or more inverse quantization offset parameters included in the displacement sub-bitstream;
determine a fixed-point offset value based on the one or more inverse quantization offset parameters;
determine a set of final wavelet coefficients based on the fixed-point offset value and the set of fixed-point dequantized coefficient values; and
determine one or more displacement vectors based on the set of final wavelet coefficients; and
reconstruct the dynamic mesh data based on the one or more displacement vectors.

2. The device of claim 1, wherein the one or more inverse quantization offset parameters include a sign parameter, a first precision parameter, and a second precision parameter.

3. The device of claim 2, wherein to determine the fixed-point offset value, the processing circuitry is further configured to:
determine a first term by performing a right bit shift operation on a fixed-point constant by an amount indicated by the first precision parameter;
determine a second term by performing a right bit shift operation on the fixed-point constant by an amount indicated by the second precision parameter; and
determine a magnitude of the fixed-point offset value by summing the first term and the second term.

4. The device of claim 3, wherein the fixed-point constant corresponds to a value of one left-shifted by a predetermined bit amount.

5. The device of claim 3, wherein to determine the fixed-point offset value, the processing circuitry is further configured to:
determine an offset sign based on the sign parameter; and
apply the offset sign to the magnitude of the fixed-point offset value to determine the fixed-point offset value.

6. The device of claim 1, wherein to determine the one or more inverse quantization offset parameters, the processing circuitry is further configured to:
determine a quantization zone based on a value of a coefficient in the set of quantized wavelet coefficients; and
select the one or more inverse quantization offset parameters corresponding to the determined quantization zone.

7. The device of claim 1, wherein to determine the one or more displacement vectors, the processing circuitry is further configured to:
retrieve a set of fixed-point predictors from a reference buffer;
add the set of fixed-point predictors to the set of final wavelet coefficients to generate a set of reconstructed fixed-point coefficients; and
determine the one or more displacement vectors based on the set of reconstructed fixed-point coefficients.

8. The device of claim 7, wherein to determine the one or more displacement vectors based on the set of reconstructed fixed-point coefficients, the processing circuitry is further configured to:
convert the set of reconstructed fixed-point coefficients into a set of floating-point coefficients; and
apply an inverse wavelet transform to the set of floating-point coefficients to determine the one or more displacement vectors.

9. The device of claim 1, wherein the processing circuitry is further configured to:
determine a base mesh based on the encoded dynamic mesh data;
deform the base mesh based on the one or more displacement vectors to generate a deformed mesh; and
output a decoded mesh based on the deformed mesh.

10. A method of decoding a bitstream of encoded dynamic mesh data, the method comprising:
arithmetically decoding a portion a displacement sub-bitstream of the encoded dynamic mesh data to determine a set of quantized wavelet coefficients;
inverse quantizing the set of quantized wavelet coefficients to determine a set of fixed-point dequantized coefficient values;
determining one or more inverse quantization offset parameters included in the displacement sub-bitstream;
determining a fixed-point offset value based on the one or more inverse quantization offset parameters;
determining a set of final wavelet coefficients based on the fixed-point offset value and the set of fixed-point dequantized coefficient values; and
determining one or more displacement vectors based on the set of final wavelet coefficients.

11. The method of claim 10, wherein the one or more inverse quantization offset parameters include a sign parameter, a first precision parameter, and a second precision parameter.

12. The method of claim 11, wherein determining the fixed-point offset value comprises:
determining a first term by performing a right bit shift operation on a fixed-point constant by an amount indicated by the first precision parameter;
determining a second term by performing a right bit shift operation on the fixed-point constant by an amount indicated by the second precision parameter; and
determining a magnitude of the fixed-point offset value by summing the first term and the second term.

13. The method of claim 12, wherein the fixed-point constant corresponds to a value of one left-shifted by a predetermined bit amount.

14. The method of claim 12, wherein determining the fixed-point offset value comprises:
determining an offset sign based on the sign parameter; and
applying the offset sign to the magnitude of the fixed-point offset value to generate the fixed-point offset value.

15. The method of claim 10, wherein determining the one or more inverse quantization offset parameters comprises:
determining a quantization zone based on a value of a coefficient in the set of quantized wavelet coefficients; and
selecting the one or more inverse quantization offset parameters corresponding to the determined quantization zone.

16. The method of claim 10, wherein determining the one or more displacement vectors comprises:
retrieving a set of fixed-point predictors from a reference buffer; and
adding the set of fixed-point predictors to the set of final wavelet coefficients to generate a set of reconstructed fixed-point coefficients.

17. The method of claim 16, wherein determining the one or more displacement vectors comprises:
converting the set of reconstructed fixed-point coefficients into a set of floating-point coefficients; and
applying an inverse wavelet transform to the set of floating-point coefficients to generate the one or more displacement vectors.

18. The method of claim 10, further comprising:
determining a base mesh based on encoded dynamic mesh data;
deforming the base mesh based on the one or more displacement vectors; and
outputting a decoded mesh based on the deformed mesh.

19. A non-transitory computer-readable medium storing instructions that, when executed by processing circuitry, cause the processing circuitry to:
arithmetically decode a portion a displacement sub-bitstream of encoded dynamic mesh data to determine a set of quantized wavelet coefficients;
inverse quantize the set of quantized wavelet coefficients to determine a set of fixed-point dequantized coefficient values;
determine one or more inverse quantization offset parameters included in the displacement sub-bitstream;
determine a fixed-point offset value based on the one or more inverse quantization offset parameters;
determine a set of final wavelet coefficients based on the fixed-point offset value and the set of fixed-point dequantized coefficient values; and
determine one or more displacement vectors based on the set of final wavelet coefficients.

20. The non-transitory computer-readable medium of claim 19, wherein the one or more inverse quantization offset parameters include a sign parameter, a first precision parameter, and a second precision parameter.

21. The non-transitory computer-readable medium of claim 20, wherein to determine the fixed-point offset value, the instructions further cause the processing circuitry to:
determine a first term by performing a right bit shift operation on a fixed-point constant by an amount indicated by the first precision parameter;
determine a second term by performing a right bit shift operation on the fixed-point constant by an amount indicated by the second precision parameter; and
determine a magnitude of the fixed-point offset value by summing the first term and the second term.

22. The non-transitory computer-readable medium of claim 21, wherein the fixed-point constant corresponds to a value of one left-shifted by a predetermined bit amount.

23. The non-transitory computer-readable medium of claim 21, wherein to determine the fixed-point offset value, the instructions further cause the processing circuitry to:
determine an offset sign based on the sign parameter; and
apply the offset sign to the magnitude of the fixed-point offset value to generate the fixed-point offset value.

24. The non-transitory computer-readable medium of claim 19, wherein to determine the one or more inverse quantization offset parameters, the instructions further cause the processing circuitry to:
determine a quantization zone based on a value of a coefficient in the set of quantized wavelet coefficients; and
select the one or more inverse quantization offset parameters corresponding to the determined quantization zone.

25. The non-transitory computer-readable medium of claim 19, wherein to determine the one or more displacement vectors, the instructions further cause the processing circuitry to:
retrieve a set of fixed-point predictors from a reference buffer; and
add the set of fixed-point predictors to the set of final wavelet coefficients to generate a set of reconstructed fixed-point coefficients.

26. The non-transitory computer-readable medium of claim 25, wherein to determine the one or more displacement vectors, the instructions further cause the processing circuitry to:
convert the set of reconstructed fixed-point coefficients into a set of floating-point coefficients; and
apply an inverse wavelet transform to the set of floating-point coefficients to generate the one or more displacement vectors.

27. The non-transitory computer-readable medium of claim 19, wherein the instructions further cause the processing circuitry to:
determine a base mesh based on encoded dynamic mesh data;
deform the base mesh based on the one or more displacement vectors; and
output a decoded mesh based on the deformed mesh.

28. A device for encoding dynamic mesh data, the device comprising:
at least one memory; and
processing circuitry in communication with the at least one memory, the processing circuitry configured to:
determine a set of displacement vectors;
determine a set of wavelet coefficients based on the set of displacement vectors;
quantize the set of wavelet coefficients to determine a set of quantized wavelet coefficients;
determine a fixed-point offset value for the displacement vectors;
arithmetically encode the set of quantized wavelet coefficients into a displacement sub-bitstream; and
include one or more offset syntax elements indicating the fixed-point offset value in the displacement sub-bitstream.

29. The device of claim 28, wherein to determine the fixed-point offset value for the displacement vectors, the processing circuitry is further configured to:
dequantize the set of quantized wavelet coefficients to determine a set of dequantized wavelet coefficients; and
determine the fixed-point offset value based on a comparison of the set of wavelet coefficients to the set of dequantized wavelet coefficients.

30. The device of claim 28, wherein the one or more offset syntax elements include a sign parameter, a first precision parameter, and a second precision parameter.
